(19) United States
(12) Patent Application Publication
(10) Pub. No.: US 2025/0026602 A1
(43) Pub. Date: Jan. 23, 2025

(54) SHEET PROCESSING APPARATUS AND IMAGE FORMING SYSTEM

(71) Applicants: Masahiro Tamura, Kanagawa (JP); Keisuke Sugiyama, Kanagawa (JP); Michitaka Suzuki, Kanagawa (JP); Yuusuke Shibasaki, Kanagawa (JP); Wataru Takahashi, Kanagawa (JP); Tomomichi Hoshino, Kanagawa (JP); Shinji Asami, Kanagawa (JP); Masanobu Kimata, Kanagawa (JP); Kei Sasaki, Kanagawa (JP)

(72) Inventors: Masahiro Tamura, Kanagawa (JP); Keisuke Sugiyama, Kanagawa (JP); Michitaka Suzuki, Kanagawa (JP); Yuusuke Shibasaki, Kanagawa (JP); Wataru Takahashi, Kanagawa (JP); Tomomichi Hoshino, Kanagawa (JP); Shinji Asami, Kanagawa (JP); Masanobu Kimata, Kanagawa (JP); Kei Sasaki, Kanagawa (JP)

(73) Assignee: Ricoh Company, Ltd., Tokyo (JP)

(21) Appl. No.: 18/774,781

(22) Filed: Jul. 16, 2024

(30) Foreign Application Priority Data
Jul. 18, 2023 (JP) 2023-117065
Apr. 8, 2024 (JP) 2024-062258

(51) Int. Cl. B65H 37/04; B31F 5/02; B42C 9/00; B65H 45/18; G03G 15/00

(52) U.S. Cl. CPC B65H 37/04; B31F 5/02; B42C 9/0081; B65H 45/18; G03G 15/6544; G03G 15/6585; B65H 2301/45; B65H 2301/51614; B65H 2301/51616; B65H 2701/13212; G03G 2215/00835

(57) ABSTRACT

A sheet processing apparatus includes a center folder, a back-crimp binder, and circuitry. The center folder performs a center-folding process to form a fold portion on a sheet bundle including multiple sheets. The back-crimp binder includes a back-portion former and a crimp binder. The back-portion former forms a back portion of the fold portion on the sheet bundle subjected to the center-folding process. The crimp binder performs a crimp-binding process on the back portion of the sheet bundle subjected to the center-folding process. The circuitry is to cause the back-crimp binder to form a crimp mark parallel to the fold portion on the back portion of the sheet bundle.

### CROSS-REFERENCE TO RELATED APPLICATIONS

This patent application is based on and claims priority pursuant to 35 U.S.C. § 119 (a) to Japanese Patent Application Nos. 2023-117065, filed on Jul. 18, 2023, and 2024-062258, filed on Apr. 8, 2024, in the Japan Patent Office, the entire disclosure of each of which is hereby incorporated by reference herein.

### BACKGROUND

### Technical Field

The present disclosure relates to a sheet processing apparatus and an image forming system.

### Related Art

There is known a sheet processing apparatus that can execute a “binding process” of binding a sheet bundle in which sheet-like recording media have been put together. Multiple types of binding process are known as binding processes to be executed in the sheet processing apparatus. For example, “edge stitching” (or “edge binding”) and “saddle stitching” (or “center binding”) are known. The “edge stitching” is for binding an edge of a sheet bundle. The “saddle stitching” is for folding a sheet bundle in two and binding the sheet bundle at a portion in the vicinity of a folding position. The saddle stitching (the center binding) is a binding method mainly used when a book such as a booklet is made.

For the purpose of providing a center-bound booklet having aligned edges without cutting the edges, there has been disclosed a center-bound bookbinding apparatus that performs square-back folding for forming a square back on a booklet after crimp binding is performed at binding positions on both sides away from a center-folding position.

In addition, for the purpose of providing a crimp-center-binding apparatus, there has been disclosed a center-bound bookbinding apparatus that performs crimp binding at a position away from a folding position.

Moreover, there has been disclosed a staple-saddle-stitching bookbinding apparatus that is a staple-saddle-stitching apparatus that performs square-back folding on the spine of a booklet, and includes a stopper plate in which a groove has been formed such that a staple is to be fitted in the groove, for the purpose of providing a booklet in which a staple is less likely to be displaced from the center of the spine for improvement in appearance.

Furthermore, for the purpose of providing a booklet bound with no staple, there has been disclosed a crimp-center-binding bookbinding apparatus that performs a center-folding process after performing the crimp binding of a booklet at a central portion thereof.

In addition, there has been disclosed a bookbinding apparatus that forms toner layers for adhesion at, for example, edges of sheets, and heats and pressurizes the toner layers to bond the sheets to each other in an electrophotographic image forming apparatus.

Sheet processing apparatuses in the related art disclose typical techniques of performing a crimp-center-binding process and performing a square-back folding process on the spine of a booklet. However, making a center-bound booklet by using these typical techniques is disadvantageous in that a double-page spread becomes incongruous when a page is turned, or a load is applied to a crimped portion by a page turning action to cause the crimped portion to be peeled off. That is, the conventional techniques have disadvantages in quality and binding strength of a completed product when crimp binding is used for saddle stitching (center binding).

### SUMMARY

Embodiments of the present disclosure described herein provide a novel sheet processing apparatus includes a center folder, a back-crimp binder, and circuitry. The center folder performs a center-folding process to form a fold portion on a sheet bundle including multiple sheets. The back-crimp binder includes a back-portion former and a crimp binder. The back-portion former forms a back portion of the fold portion on the sheet bundle subjected to the center-folding process. The crimp binder performs a crimp-binding process on the back portion of the sheet bundle subjected to the center-folding process. The circuitry is to cause the back-crimp binder to form a crimp mark parallel to the fold portion on the back portion of the sheet bundle.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming system according to a first embodiment;

FIG. 2 is a diagram illustrating an internal structure of a post-processing apparatus according to the first embodiment;

FIG. 3 is a schematic diagram illustrating an edge binder viewed from an ejection port side;

FIGS. 4A and 4B are schematic diagrams illustrating configurations of crimping teeth of a crimp-edge-binding processing unit;

FIGS. 5A, 5B, 5C, 5D and 5E are diagrams illustrating movement positions of the edge binder;

FIGS. 6A, 6B, 6C, 6D and 6E are schematic diagrams illustrating operation of a crimp center binder;

FIGS. 7A, 7B and 7C are cross-sectional views of the crimp center binder, which illustrate operation of the crimp center binder;

FIG. 8 is a schematic diagram illustrating a state of pressing performed by the crimp center binder;

FIG. 9 is a schematic view of a crimp-center-bound booklet bound in the first embodiment;

FIG. 10 is a hardware configuration diagram of a control device of the post-processing apparatus;

FIG. 11 is a schematic diagram illustrating a first modification of the crimp center binder;

FIGS. 12A and 12B are cross-sectional views taken along line B-B, which illustrate operation of the crimp center binder according to the first modification;

FIGS. 13A and 13B are cross-sectional views of a crimp center binder according to a second modification, which illustrate operation of the crimp center binder;

FIGS. 14A and 14B are cross-sectional views of a crimp center binder according to a third modification, which illustrate operation of the crimp center binder;

FIGS. 15A, 15B, and 15C are cross-sectional views of a crimp center binder according to a fourth modification, which illustrate operation of the crimp center binder;

FIGS. 16A, 16B and 16C are cross-sectional views of a crimp center binder according to a fifth modification, which illustrate operation of the crimp center binder;

FIG. 17 is a schematic view of a crimp-center-bound booklet bound in the fifth modification;

FIG. 18 is a schematic diagram illustrating a sixth modification of the crimp center binder;

FIG. 19 is a schematic view of a crimp-center-bound booklet bound in the sixth modification;

FIG. 20 is a schematic diagram illustrating a seventh modification of the crimp center binder;

FIG. 21 is a schematic view of a crimp-center-bound booklet bound in the seventh modification;

FIG. 22 is a schematic diagram illustrating an eighth modification of the crimp center binder;

FIGS. 23A, 23B, and 23C are cross-sectional views of a crimp center binder according to the eighth modification, which illustrate operation of the crimp center binder;

FIGS. 24A and 24B are schematic views of a crimp-center-bound booklet bound in the eighth modification;

FIGS. 25A and 25B are cross-sectional views of a crimp center binder according to a ninth modification, which illustrate operation of the crimp center binder;

FIG. 26 is a diagram illustrating an overall configuration of an image forming system according to a second embodiment; and

FIG. 27 is a diagram illustrating an internal structure of a post-processing apparatus according to the second embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

### First Embodiment

A first embodiment of a sheet processing apparatus, a sheet processing method, and an image forming system according to the present disclosure will be described with reference to the drawings.

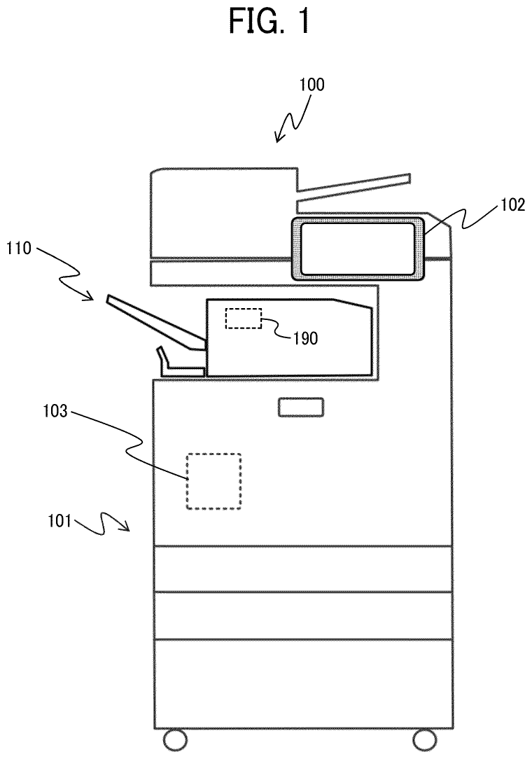

FIG. 1 is a diagram illustrating an overall configuration of an image forming system 100 such as a multifunction printer (MFP), as a first embodiment of the image forming system.

As illustrated in FIG. 1, the image forming system 100 includes an image forming apparatus 101 and a post-processing apparatus 110. The image forming apparatus 101 forms an image on a sheet P corresponding to an example of a sheet material as a sheet-like medium. The post-processing apparatus 110 executes predetermined post-processing on the sheet P on which an image has been formed. The image forming system 100 corresponds to an embodiment of an in-body image forming system in which the post-processing apparatus 110 is disposed in an in-body space of the image forming apparatus 101.

The image forming apparatus 101 forms an image on the sheet P, and ejects the sheet P on which the image has been formed to the post-processing apparatus 110. The image forming apparatus 101 includes a tray, a conveyor, and an image former. Sheets P are stored in the tray. The conveyor conveys a sheet P stored in the tray. The image former forms an image on the sheet P conveyed by the conveyor. The image former can execute a known image forming method. For example, the image former may use an inkjet method for discharging liquid ink toward the sheet P and causing the liquid ink to adhere to the sheet P to form an image, or may use an electrophotographic method for forming an image by using toner.

The image forming apparatus 101 includes an operation panel 102, and a controller 103 that controls the operations of the image forming apparatus 101. The configuration and operation of the image forming apparatus 101 correspond to the configuration and operation known in the art, and thus detailed description thereof will be omitted.

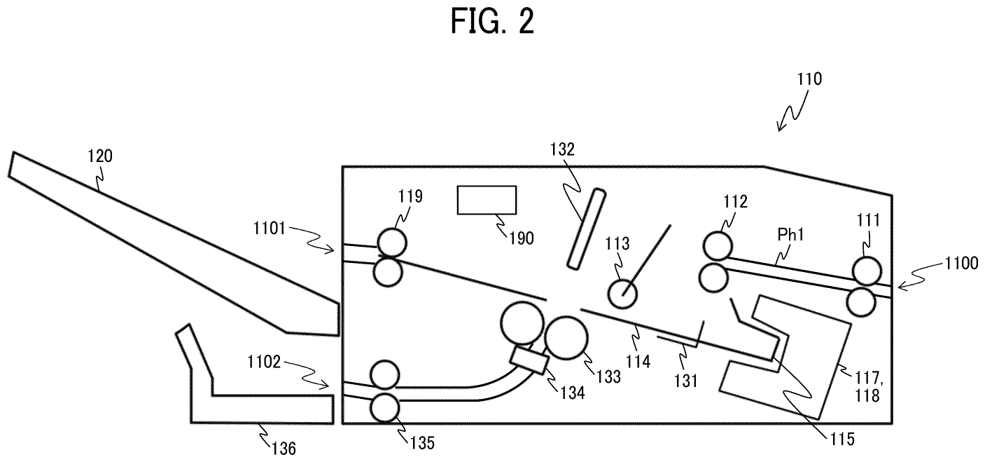

Next, a detailed description will be given of the post-processing apparatus 110 as an embodiment of the sheet processing apparatus according to the present disclosure. FIG. 2 is a diagram illustrating an internal structure of the post-processing apparatus 110 according to the first embodiment. The post-processing apparatus 110 has a function of performing post-processing on the sheet P on which an image has been formed by the image forming apparatus 101. The post-processing apparatus 110 performs a binding process of receiving the sheet P on which an image has been formed through a carry-in port 1100, through which the sheet P is received from the image forming apparatus 101, and binding a sheet bundle Pb in which a plurality of sheets has been put together.

More specifically, the binding according to the present embodiment includes “crimp binding” and “stapling.” The crimp binding is a process of pressing and deforming the sheet bundle Pb, which includes a plurality of stacked sheets P, at a binding position to bind the sheet bundle Pb. The stapling is a process of binding the sheet bundle Pb with a staple at the binding position. The crimp binding includes edge binding and center binding. The edge binding is a process to bind an edge of the sheet bundle Pb. The center binding is a process to bind the center of the sheet bundle Pb.

The post-processing apparatus 110 includes a first conveyance roller pair 111 and a second conveyance roller pair 112 for conveying the sheet P carried in through the carry-in port 1100 along a conveyance path. The first conveyance roller pair 111 and the second conveyance roller pair 112 convey the sheet P fed from the image forming apparatus 101 along a first conveyance path Ph1 inside the post-processing apparatus 110.

The first conveyance path Ph1 is a path extending from the carry-in port 1100, through which the sheet P is carried in from the image forming apparatus 101, to an inner tray 114.

### Edge Binding

The post-processing apparatus 110 includes a return conveyance roller 113, the inner tray 114, an end fence 115, side fences 116, a staple-edge-binding processing unit 117, a crimp-edge-binding processing unit 118, an ejection roller pair 119, and an ejection tray 120. The staple-edge-binding processing unit 117 and the crimp-edge-binding processing unit 118 function as edge binders.

The return conveyance roller 113 functions as a conveyance roller for placing, on the inner tray 114, the sheet P having passed through the second conveyance roller pair 112, and conveying the sheet P on the inner tray 114 toward the end fence 115. A direction of conveyance by the return conveyance roller 113 is different from a direction of conveyance by the first conveyance roller pair 111 and the second conveyance roller pair 112, and corresponds to a direction (reverse direction) in which the sheet P conveyed by the first conveyance roller pair 111 and the second conveyance roller pair 112 is turned around. Therefore, the conveyance by the return conveyance roller 113 is referred to as switchback conveyance.

The sheet P as a sheet material is conveyed to the inner tray 114 by the first conveyance roller pair 111, the second conveyance roller pair 112, and the return conveyance roller 113, and is subjected to a binding process. The first conveyance roller pair 111, the second conveyance roller pair 112, the return conveyance roller 113, and the first conveyance path Ph1 form a conveyor that conveys the sheet P to the inner tray 114 functioning as a stacker.

The inner tray 114 corresponds to a stacker on which a plurality of sheets P sequentially conveyed is temporarily placed. The sheets P placed on the inner tray 114 are switchback-conveyed by the return conveyance roller 113 to a position where the sheets P collide with the end fence 115. The end fence 115 functions as an alignment member for aligning edges of the sheets P in the direction of the switchback conveyance. Edges of the plurality of sheets P stacked on the inner tray 114 are aligned by the end fence 115 to form the sheet bundle Pb.

A pair of the side fences 116 is disposed in a width direction of the inner tray 114 (width direction of the sheets P). In other words, the pair of side fences 116 is disposed at both side ends of the inner tray 114 in a direction orthogonal to the direction in which the sheets P are switchback-conveyed, that is, the direction in which the sheets P are conveyed to the end fence 115.

The side fences 116 perform “jogging operation” in which the side fences 116 repeat coming into contact with and separating from the width-directional edges of the plurality of sheets P stacked on the inner tray 114. By this jogging operation, the width-directional edges of the plurality of sheets P are also aligned. That is, the side fences 116 function as an alignment member for aligning both width-directional edges (both edges in the direction orthogonal to the conveyance direction) of the sheets P placed on the inner tray 114.

The staple-edge-binding processing unit 117 and the crimp-edge-binding processing unit 118 functioning as edge-binders perform a binding process on an edge of the sheet bundle Pb aligned by the end fence 115 and the side fences 116.

After the binding process is performed, the return conveyance roller 113 rotates in contact with the sheet bundle Pb placed on the inner tray 114. A direction of the rotation performed at this time is opposite to a direction of rotation performed during switchback conveyance. Therefore, the sheet bundle Pb subjected to edge stitching is ejected from a first ejection port 1101 toward the ejection tray 120 by the return conveyance roller 113.

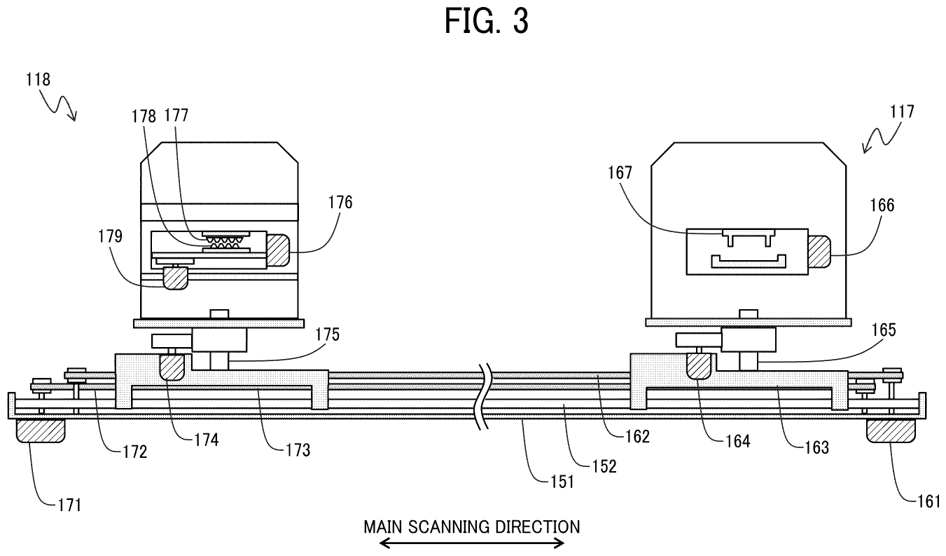

The “edge stitching” to be performed on the sheet bundle Pb by the staple-edge-binding processing unit 117 and the crimp-edge-binding processing unit 118 includes multiple types of processes, for example, the “edge stitching” includes a “parallel-binding process,” an “oblique-binding process,” and a “two-location-binding process.” In the “parallel-binding process,” binding is performed along one side parallel to a main scanning direction (see FIG. 3) of the sheet bundle Pb. In the “oblique-binding process,” binding is performed at a corner of the sheet bundle Pb. In the “two-location-binding process,” binding is performed at a plurality of locations separated in the width direction along one side parallel to the conveyance direction of the sheet bundle Pb.

FIG. 3 is a schematic diagram illustrating an edge-stitching unit 1110 including the staple-edge-binding processing unit 117 and the crimp-edge-binding processing unit 118, as viewed in a direction from the first ejection port 1101 toward the end fence 115. As illustrated in FIG. 3, the edge-stitching unit 1110 is attached to an edge-stitching unit base member 151 in a state where the staple-edge-binding processing unit 117 and the crimp-edge-binding processing unit 118 are separated from each other in the main scanning direction. The edge-stitching unit 1110 is supported by a guide shaft 152 extending in the main scanning direction, via the edge-stitching unit base member 151. Therefore, both the staple-edge-binding processing unit 117 and the crimp-edge-binding processing unit 118 are supported in such a way as to be movable along the guide shaft 152.

The staple-edge-binding processing unit 117 includes a staple-edge-binding main scanning motor 161, a driving force transmission mechanism 162, and a staple-edge-binding processing unit base member 163. The staple-edge-binding processing unit 117 is movable in the main scanning direction along the guide shaft 152 by the driving force of the staple-edge-binding main scanning motor 161.

The staple-edge-binding main scanning motor 161 generates a driving force for moving the staple-edge-binding processing unit 117. The driving force transmission mechanism 162 transmits the driving force of the staple-edge-binding main scanning motor 161 to the staple-edge-binding processing unit base member 163 via a pulley and a timing belt. Accordingly, the staple-edge-binding processing unit 117 is movable in the main scanning direction along the guide shaft 152.

The staple-edge-binding processing unit 117 further includes a staple-edge-binding posture rotation motor 164, and rotates about a stapling rotation shaft 165 as a rotation center with respect to the staple-edge-binding processing unit base member 163.

In addition, the staple-edge-binding processing unit 117 includes a staple-edge-binding clinch motor 166, and causes a staple clincher 167 to perform an opening-and-closing operation. Thus, a staple penetrates the sheet bundle Pb, then is clinched to execute stapling.

The crimp-edge-binding processing unit 118 includes a crimp-edge-binding main scanning motor 171, a driving force transmission mechanism 172, and a crimp-edge-binding processing unit base member 173. The crimp-edge-binding processing unit 118 is movable in the main scanning direction along the guide shaft 152 by the driving force of the crimp-edge-binding main scanning motor 171.

The crimp-edge-binding main scanning motor 171 generates a driving force for moving the crimp-edge-binding processing unit 118. The driving force transmission mechanism 172 transmits the driving force of the crimp-edge-binding main scanning motor 171 to the crimp-edge-binding processing unit base member 173 via a pulley and a timing belt. As a result, the crimp-edge-binding processing unit 118 becomes movable in the main scanning direction along the guide shaft 152.

Furthermore, the crimp-edge-binding processing unit 118 includes a crimp-edge-binding posture rotation motor 174, and rotates about a crimp-binding rotation shaft 175 as a rotation center with respect to the crimp-edge-binding processing unit base member 173.

In addition, the crimp-edge-binding processing unit 118 includes a crimp-edge-binding clinch motor 176, and causes “opening/closing operation” to be performed by the driving force of the crimp-edge-binding clinch motor 176. In the opening/closing operation, upper crimping teeth 177 approach or separate from lower crimping teeth 178. With this opening/closing operation, it is possible to nip the edge of the sheet bundle Pb between the upper crimping teeth 177 and the lower crimping teeth 178 having a protruding-recessed shape and to press and deform the sheet bundle Pb. Due to this pressure deformation, fibers of the sheets P included in the sheet bundle Pb are entangled with each other to form the sheet bundle Pb of the plurality of sheets P. As described above, binding based on pressure deformation is referred to as “crimp binding.”

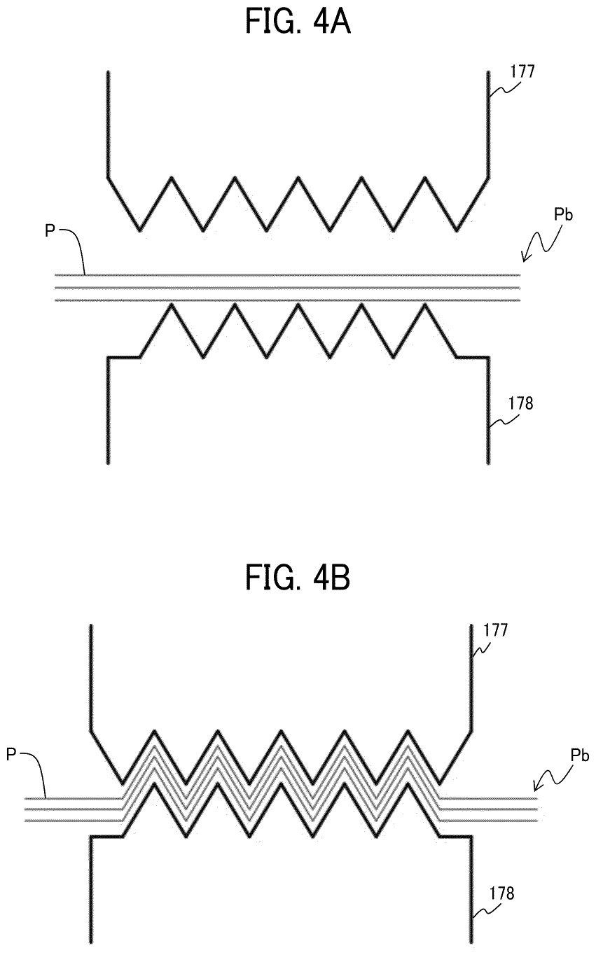

FIGS. 4A and 4B are schematic diagrams illustrating configurations of the upper crimping teeth 177 and the lower crimping teeth 178 each functioning as a crimping portion included in the crimp-edge-binding processing unit 118. As illustrated in FIGS. 4A and 4B, the crimping portion includes a pair of upper crimping teeth 177 and lower crimping teeth 178. The upper crimping teeth 177 and the lower crimping teeth 178 are arranged in such a way as to face each other in a thickness direction of the sheet bundle Pb such that the sheet bundle Pb placed on the inner tray 114 can be sandwiched between the upper crimping teeth 177 and the lower crimping teeth 178. The upper crimping teeth 177 and the lower crimping teeth 178 are formed in a protruding-recessed shape in which recesses and protrusions are alternately formed. In addition, the upper crimping teeth 177 and the lower crimping teeth 178 are formed such that the recesses and protrusions are displaced so that the upper crimping teeth 177 and the lower crimping teeth 178 can engage with each other. The crimping portion is configured such that the upper crimping teeth 177 opens and closes with respect to (comes into contact with and separates from) the lower crimping teeth 178 by the driving force of the crimp-edge-binding clinch motor 176.

In the process of feeding the plurality of sheets P to be included in the sheet bundle Pb to the inner tray 114, the upper crimping teeth 177 and the lower crimping teeth 178 are separated from each other as illustrated in FIG. 4A. Then, when all the sheets P to be included in the sheet bundle Pb are placed on the inner tray 114 and predetermined alignment operation (operation of aligning the edges) is completed, the crimp-edge-binding processing unit 118 moves to a binding position, and the upper crimping teeth 177 and the lower crimping teeth 178 approach and engage with each other as illustrated in FIG. 4B. That is, the upper crimping teeth 177 and the lower crimping teeth 178 nip the sheet bundle Pb at a predetermined binding portion thereof to press and deform the sheet bundle Pb from the thickness direction. As a result, the sheet bundle Pb placed on the inner tray 114 is crimped and bound. Then, the sheet bundle Pb having been crimped and bound is ejected from the first ejection port 1101 toward the ejection tray 120 by the ejection roller pair 119.

The crimp-edge-binding processing unit 118 just needs to exert a function of pressurizing the sheet bundle Pb to crimp a specific portion. Therefore, the upper crimping teeth 177 and the lower crimping teeth 178 just need to be configured such that the upper crimping teeth 177 and the lower crimping teeth 178 can engage with each other to pressurize the sheet bundle Pb when the sheet bundle Pb is sandwiched between the upper crimping teeth 177 and the lower crimping teeth 178 to be bound. Therefore, a configuration that allows execution of the operation of closing the upper crimping teeth 177 and the lower crimping teeth 178 is not limited to the exemplary configuration disclosed in the present embodiment. For example, a link mechanism-type crimping mechanism may be used (for example, disclosed in Japanese Patent No. 6057167) which performs operation of causing the upper crimping teeth 177 and the lower crimping teeth 178 to approach (crimp) and separate from each other, by a drive source and a link mechanism that perform only forward rotation or forward and reverse rotation. In addition, a linear motion-type crimping mechanism may be used which causes the upper crimping teeth 177 and the lower crimping teeth 178 to linearly perform crimping and separating operation, by a screw mechanism that converts rotational motion of a drive source into linear motion.

In addition, as illustrated in FIG. 3, the crimping portion includes a binding-tooth slide mechanism for moving the upper crimping teeth 177 and the lower crimping teeth 178 relative to a frame of the crimp-edge-binding processing unit 118. The binding-tooth slide mechanism includes a binding-teeth slide motor 179 and a drive transmission mechanism. The drive transmission mechanism functions as a linear-motion conversion mechanism, such as a rack-and-pinion mechanism or a crankshaft mechanism, which transmits the driving force of the binding-teeth slide motor 179. When the driving force from the binding-teeth slide motor 179 is transmitted to the upper crimping teeth 177 and the lower crimping teeth 178 by the drive transmission mechanism, the upper crimping teeth 177 and the lower crimping teeth 178 slide along respective longitudinal directions (longitudinal direction of the edge-stitching unit base member 151).

Here, the amount of slide movement of the upper crimping teeth 177 and the lower crimping teeth 178 is equivalent to, for example, a crimp mark length. Then, the upper crimping teeth 177 and the lower crimping teeth 178 perform crimp-binding operation multiple times before and after the slide movement. That is, when the length of each crimp mark by the upper crimping teeth 177 and the lower crimping teeth 178 is 10 mm, the amount of slide movement is also set to 10 mm. Thus, a crimp mark having a length of 20 mm in total can be obtained by crimping operation (first stroke) before the slide movement and crimping operation (second stroke) after the slide movement. As a result, the binding force is improved about twofold.

### Outline of Binding Process

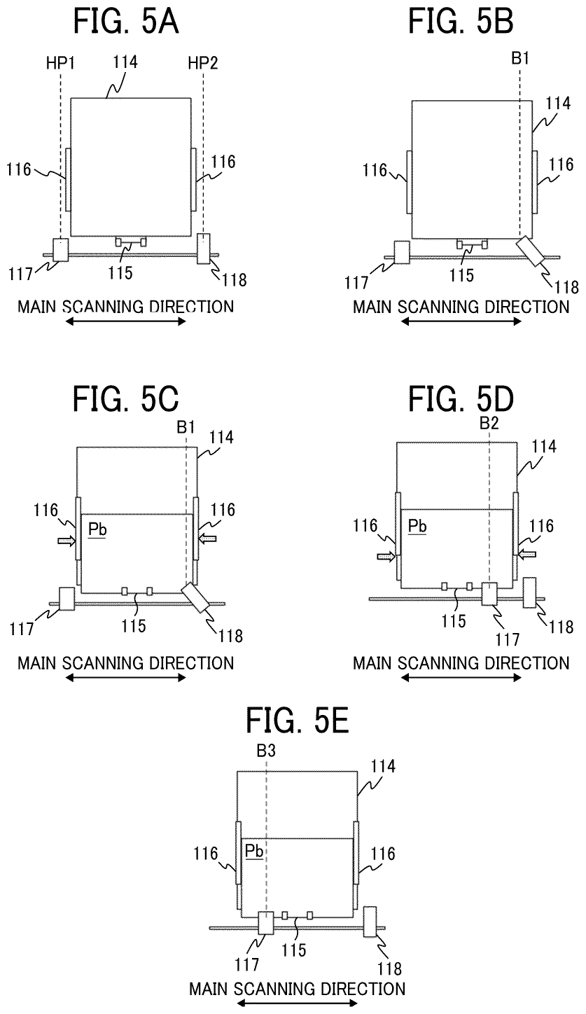

FIGS. 5A to 5E are diagrams illustrating positions of the staple-edge-binding processing unit 117 and the crimp-edge-binding processing unit 118 according to operations in the binding process. FIG. 5A illustrates a standby state for the binding process. As illustrated in FIG. 5A, in the standby state, the staple-edge-binding processing unit 117 is located at a stapling standby position HP1. The crimp-edge-binding processing unit 118 is located at a crimp-binding standby position HP2.

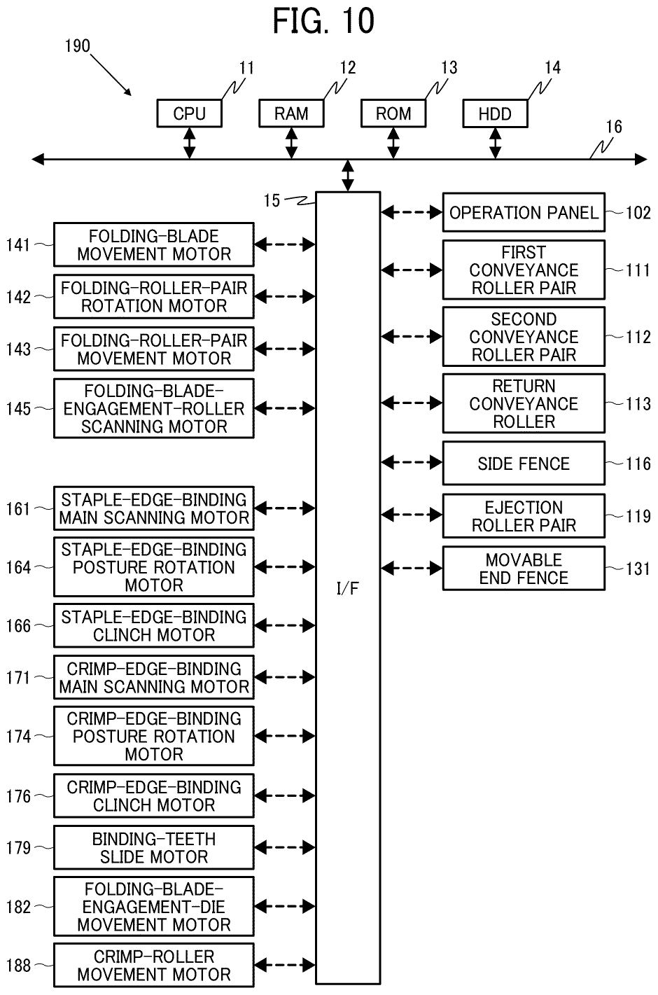

FIGS. 5B and 5C illustrate a state in which an oblique-binding process is performed by the crimp-edge-binding processing unit 118. As illustrated in FIGS. 5B, before a first sheet P1 to be included in the sheet bundle Pb is fed to the inner tray 114, the crimp-edge-binding processing unit 118 is moved in the main scanning direction and obliquely rotated so that the crimp-edge-binding processing unit 118 can face a first binding position B1. The movement and rotation of the crimp-edge-binding processing unit 118 are controlled by a controller 190 functioning as a control device to be described below with reference to FIG. 10.

Subsequently, as illustrated in FIG. 5C, the controller 190 causes jogging operation to be executed each time the sheet P is conveyed to the inner tray 114, in a state where the crimp-edge-binding processing unit 118 has been disposed at a position where the crimp-edge-binding processing unit 118 faces the first binding position B1. The jogging operation is executed by the controller 190 performing control in such a way as to cause the side fences 116 to slide in the width direction.

Subsequently, in the state illustrated in FIG. 5C, the controller 190 repeats stacking and alignment operation of the sheets P until the number of sheets P to be included in the sheet bundle Pb reaches a predetermined number N.

Next, when detecting that the number of sheets P placed on the inner tray 114 has reached the predetermined number N, the controller 190 causes the crimp-edge-binding processing unit 118 to operate so as to perform crimp-binding operation at the first binding position B1 of the sheet bundle Pb placed on the inner tray 114.

Next, the controller 190 ejects, to the ejection tray 120, the sheet bundle Pb subjected to the crimp binding at the first binding position B1. Furthermore, the controller 190 moves the crimp-edge-binding processing unit 118 to the crimp-binding standby position HP2 illustrated in FIG. 5A.

FIGS. 5D and 5E illustrate a state in which a two-location-binding process is performed by the staple-edge-binding processing unit 117. A second binding position B2 and a third binding position B3 are separated from each other in the main scanning direction. Before the first sheet P1 to be included in the sheet bundle Pb is fed to the inner tray 114, the controller 190 moves the staple-edge-binding processing unit 117 in the main scanning direction so that the staple-edge-binding processing unit 117 can face the second binding position B2. Next, as illustrated in FIG. 5D, the controller 190 causes the side fences 116 to execute jogging operation in a state where the staple-edge-binding processing unit 117 has been moved to a position where the staple-edge-binding processing unit 117 can face the second binding position B2.

Subsequently, in the state illustrated in FIG. 5D, the controller 190 repeats stacking and alignment operation of the sheets P until the number of sheets P to be included in the sheet bundle Pb reaches the predetermined number N.

Next, when detecting that the number of sheets P placed on the inner tray 114 has reached the predetermined number N, the controller 190 causes the staple-edge-binding processing unit 117 to operate so as to perform stapling operation at the first binding position B1 of the sheet bundle Pb placed on the inner tray 114.

Next, as illustrated in FIG. 5E, the controller 190 causes the staple-edge-binding processing unit 117 to face the third binding position B3 and perform stapling operation at the third binding position B3 of the sheet bundle Pb placed on the inner tray 114.

In the examples of FIGS. 5A to 5E, after binding is performed at the second binding position B2 in the two-location binding, binding is performed at the third binding position B3. However, the order of execution of the two-location binding is not limited thereto. That is, the two-location binding may be executed such that the second binding position B2 is bound after the third binding position B3 is bound. In a case where the number of sheet bundles to be bound is continuous, for example, the third binding position B3 is bound after the second binding position B2 is bound for an odd-numbered sheet bundle, and the second binding position B2 is bound after the third binding position B3 is bound for an even-numbered sheet bundle. When the binding process is thus performed by rearrangement of the order of binding positions according to the order in the entire sheet bundles to be bound, efficiency of the binding process can be improved.

Next, the controller 190 ejects, to the ejection tray 120, the sheet bundle Pb stapled at the second binding position B2 and the third binding position B3. In addition, the controller 190 moves the staple-edge-binding processing unit 117 to the stapling standby position HP1 as illustrated in FIG. 5A.

The example of oblique binding of a corner of the sheet bundle Pb or two-location binding of two portions of the sheet bundle Pb has been described in the above embodiment. However, the present disclosure is also applicable to a case of binding three or more portions of the sheet bundle Pb separated in the main scanning direction.

### Outline of Crimp-Center-Binding Processing Unit

Here, referring back to FIG. 2, a detailed description will be given of a portion that performs a crimp-center-binding process in the configuration of the post-processing apparatus 110. As illustrated in FIG. 2, the post-processing apparatus 110 includes a movable end fence 131, a folding blade 132, a folding roller pair 133, a folding-blade engagement roller 134, a center-folded booklet ejection roller pair 135, and a center-folded booklet ejection tray 136 in addition to the return conveyance roller 113, the inner tray 114, and the side fences 116.

The movable end fence 131, the folding blade 132, and the folding roller pair 133 form a center folder. Furthermore, the folding blade 132, the folding roller pair 133, and the folding-blade engagement roller 134 form a crimp-center-binder.

The movable end fence 131 is a mechanism that moves edges of the sheets P placed on the inner tray 114 in the conveyance direction and aligns a center-folding position with the position of the folding blade 132 as a folding plate. The center-folding position is set in the vicinity of the center of the sheets P in the conveyance direction.

After the predetermined number N of sheets P to be included in the sheet bundle Pb are stacked on the inner tray 114 and the alignment process is completed, the movable end fence 131 moves to adjust the center-folding position of the sheet bundle Pb such that the center-folding position faces the folding blade 132. Alternatively, at the stage of placing the predetermined number N of sheets P to be included in the sheet bundle Pb, the position of the movable fence may be moved such that the center-folding position of the sheet bundle Pb faces the folding blade 132, and then the sheets P may be placed on the inner tray 114. In either case, adjustment is made such that the center-folding position on the sheet bundle Pb is set to a position where the sheet bundle Pb is pushed into the folding roller pair 133 by the folding blade 132. Then, in a state where these adjustments have been made, the crimp-center-binding process is executed by operation of the folding blade 132, the folding roller pair 133, and the folding-blade engagement roller 134.

More specifically, the return conveyance roller 113 switchback-conveys the sheet P toward the movable end fence 131 at a timing when the sheet P conveyed from the image forming apparatus 101 is placed on the inner tray 114 after passing through the second conveyance roller pair 112. A series of processes leading to the switchback conveyance corresponds to a conveyance process. At this time, the movable end fence 131 may have already moved to a position corresponding to the center-folding position, or may be at the same position as the end fence 115.

A plurality of sheets P sequentially conveyed is temporarily placed on the inner tray 114. The movable end fence 131 is provided for the inner tray 114 such that the movable end fence 131 can move away from the end fence 115 in the conveyance direction. The movable end fence 131 is a member movable in the conveyance direction of the sheets P along the inner tray 114. The movable end fence 131 corresponds to a constituent element that is moved under the control of the controller 190 according to the conveyance direction length of the sheets P placed on the inner tray 114 (synonymous with the conveyance direction length in the switchback conveyance) to change the positions of the sheets P. The position of the movable end fence 131 is set such that a center position in the conveyance direction length of the sheets P faces the folding blade 132.

The side fences 116 align the sheets P or the sheet bundle Pb placed on the inner tray 114 in the main scanning direction (width direction). A crimp-center-binding apparatus unit performs the crimp-center-binding process on the sheet bundle Pb aligned by the movable end fence 131 and the side fences 116. The sheet bundle Pb subjected to the crimp-center-binding process is ejected by the center-folded booklet ejection roller pair 135, and is placed on the center-folded booklet ejection tray 136 via a second ejection port 1103.

### Operation of Crimp-Center-Binding Apparatus

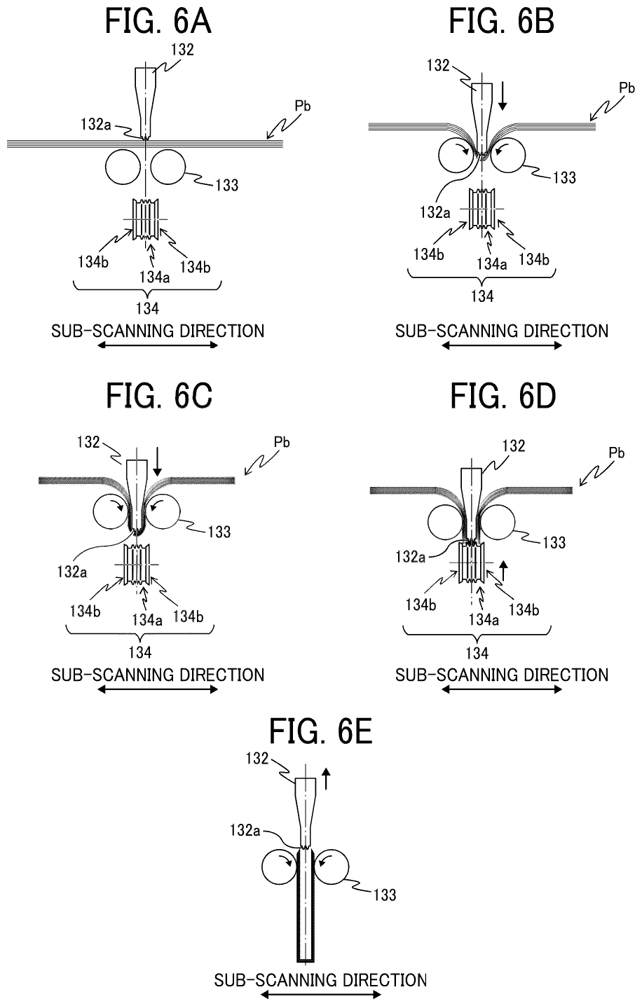

Next, steps of operation of the crimp-center-binding apparatus will be described with reference to FIGS. 6A to 6E. FIGS. 6A to 6E are schematic diagrams mainly illustrating the folding blade 132 as a folding-plate member, the folding roller pair 133 as a folding-roller-pair member, and the folding-blade engagement roller 134 as a planar folding-plate engagement member, which form the crimp-center-binding apparatus. FIGS. 6A to 6E illustrate an outline of center-folding binding to be executed by operation of these members. FIG. 6A illustrates a state in which after the conveyance operation and a stacking operation, the sheet bundle Pb is placed on the inner tray 114 and the edges of the sheets P are aligned, so that all the sheets P are aligned. In FIG. 6A, the folding blade 132, the folding roller pair 133, and the folding-blade engagement roller 134 are located at initial positions.

At the initial position, the folding blade 132 is substantially perpendicular to the sheet bundle Pb, and is separated from a surface of the sheet bundle Pb. At the initial position, the folding blade 132 faces a folding position at which the sheet bundle Pb is center-folded, and advances and retreats in the thickness direction of the sheet bundle Pb by a folding-blade movement motor 141 (FIG. 10) included in a folding-plate member moving mechanism. The folding blade 132 advances and retreats with respect to the sheet bundle Pb between a pushing position and a retracted position in a center-folding operation of folding a central portion of the conveyance direction length as a part of the sheet bundle Pb. A fold portion is formed at the pushing position. The folding blade 132 is removed from the sheet bundle Pb at the retracted position after the center of the sheet bundle Pb is folded. The retracted position of the folding blade 132 corresponds to an initial position (HP position).

The folding roller pair 133 is disposed symmetrically with respect to a center line of the folding blade 132. That is, the folding roller pair 133 is disposed symmetrically with respect to the center line along a direction in which the folding blade 132 moves when performing a center-folding action on the sheets P. The folding roller pair 133 is rotated by a folding-roller-pair rotation motor 142 (see FIG. 10). In addition, the folding roller pair 133 has a configuration that allows the folding roller pair 133 to approach and separate from each other by a folding-roller-pair movement motor 143 (see FIG. 10) included in a pressurizing mechanism.

The distance between a pair of rollers included in the folding roller pair 133 is adjusted under the control of the controller 190. When the sheet bundle Pb is pushed toward the nip position of the folding roller pair 133 by the folding blade 132, the pair of rollers of the folding roller pair 133 is set to a “receiving position” under the control of the controller 190. At the receiving position, the nip position is separated according to a separation amount that is a predetermined amount. Note that before the center-folding process is started, the controller 190 may set the position of the folding roller pair 133 to a position where the folding roller pair 133 is separated from each other further than in the receiving position. The “receiving position” where the sheet bundle Pb is received is also regarded as a position where the folding roller pair 133 is located during standby in the center-folding binding. Thus, the receiving position also corresponds to a standby position.

The folding-blade engagement roller 134 included in a crimp binder is a cylindrical roller-shaped member. A rotation axis of the folding-blade engagement roller 134 is set in a direction passing through both ends sandwiching a cylindrical portion. The folding-blade engagement roller 134 is pivotally supported such that the folding-blade engagement roller 134 can rotate about the rotation axis. The folding-blade engagement roller 134 includes an engaging-crimping teeth portion 134a on the outer peripheral portion of the cylindrical portion (cylindrical outer peripheral surface). A plurality of ring-shaped protrusions is disposed in the sub-scanning direction to form the engaging-crimping teeth portion 134a. The folding-blade engagement roller 134 also includes flange portions 134b at both ends of the cylindrical portion. Each flange portion 134b has an outer diameter larger than the outer diameter of the engaging-crimping teeth portion 134a. The flange portions 134b functioning as flange portions are equal in diameter at both ends of the cylindrical portion.

Teeth of the engaging-crimping teeth portion 134a included in the folding-blade engagement roller 134 have multiple projections and recesses at given intervals on the outer peripheral surface of the cylindrical portion of the folding-blade engagement roller 134 in the axial direction of the rotation axis. The multiple protrusions and recesses are extended in a direction orthogonal to the rotation axis of the folding-blade engagement roller 134 on the outer peripheral surface of the folding-blade engagement roller 134.

First, the center-folding process is executed in the crimp-center-binding process according to the present embodiment. In the center-folding process, first, the controller 190 adjusts positions of the pair of rollers included in the folding roller pair 133 by the folding-roller-pair movement motor 143 to bring the sheet bundle Pb into a state where the sheet bundle Pb can be received. The folding-roller-pair movement motor 143 adjusts a gap at the nip position of the folding roller pair 133. The adjustment amount (separation amount) at this time is for forming a gap to such an extent that the folding blade 132 pushes an area in the vicinity of the conveyance direction (length direction) center of the sheet bundle Pb to the nip position (gap) of the folding roller pair 133 and that the folding blade 132 can advance in the nip position while pushing the sheet bundle Pb. Therefore, the adjustment amount of the gap at the receiving position of the folding roller pair 133 is changed according to, for example, the predetermined number N of sheets P to be included in the sheet bundle Pb and size information including the size and thickness of the sheet P.

That is, as a previous stage of the center-folding process, when the folding blade 132 guides the sheet bundle Pb to a position between the rollers of the folding roller pair 133 (nip position), the controller 190 separates the rollers from each other so that the folding blade 132 and the sheet bundle Pb can pass between the rollers. For example, outer peripheries of the rollers are slightly separated from each other at the “receiving position” at which the rollers included in the folding roller pair 133 are located at this time.

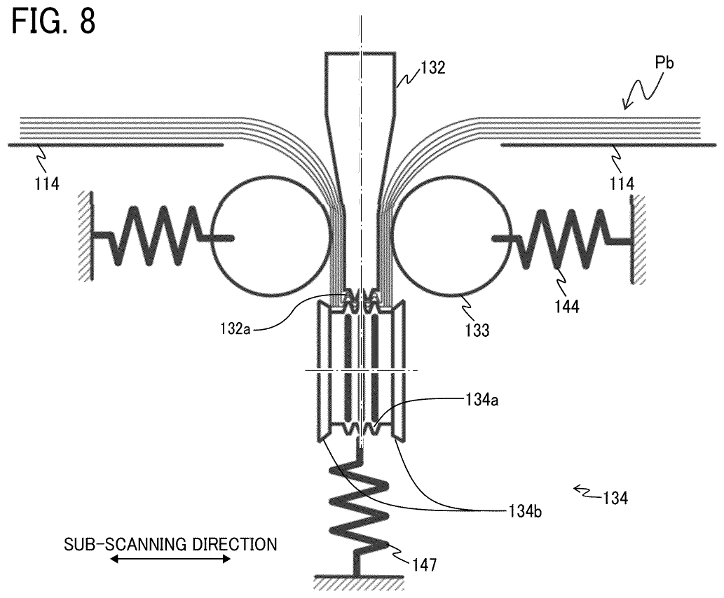

Subsequently, as illustrated in FIG. 6B, the folding blade 132 guides the sheet bundle Pb toward the nip position of the folding roller pair 133. At this time, the elastic force of a folding-roller-pair pressurizing member 144 (see FIG. 8) presses the folding roller pair 133 toward the sheet bundle Pb. In other words, the degree to which the sheet bundle Pb is pressed by the folding blade 132 is determined by the elastic force of the folding-roller-pair pressurizing member 144. A fold portion is formed on the sheet bundle Pb by the pressing of the folding roller pair 133 to the sheet bundle Pb and the advancing of the folding blade 132.

Information for adjusting the receiving position of the folding roller pair 133 (type and thickness of sheet P and number of sheets P to be included in one unit of sheet bundle Pb) is preset in the controller 190 via an operation panel 102. That is, at the time of starting the center-folding process, the controller 190 calculates an adjustment value based on the number of sheets P to be included in the sheet bundle Pb that has already been set, the type of sheet P (mainly a difference in thickness), and the like, and then, adds the thickness of the folding blade 132 to the adjustment value. The controller 190 uses the value thus obtained as a gap adjustment amount.

As illustrated in FIG. 6B, the folding blade 132 as a rack-type crimping blade advances toward the folding roller pair 133 subjected to gap adjustment while pushing the sheet bundle Pb. At this time, the folding roller pair 133 functioning as a center folder rotates in accordance with the traveling speed of the folding blade 132 to press the sheet bundle Pb in a direction orthogonal to the traveling direction. In other words, the folding blade 132 and the sheet bundle Pb guided by the folding blade 132 that is advancing are pushed into the folding roller pair 133. When the sheet bundle Pb is pushed into the folding roller pair 133, the pushing position of the sheet bundle Pb is bent. Thus, the folding is executed. When the sheet bundle Pb is guided (pushed) between the folding roller pair 133 by the folding blade 132, the gap between the folding roller pair 133 is widened by an amount corresponding to a value twice as much as the thickness of the sheet bundle Pb.

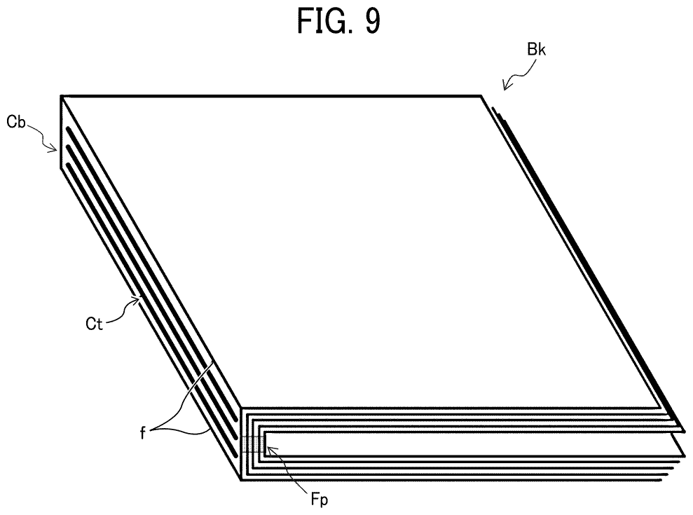

Furthermore, as illustrated in FIG. 6C, a tip of the folding blade 132 continues to advance to a position much beyond the nip position of the folding roller pair 133, and the center-folding process for the sheet bundle Pb proceeds. In this center-folding process, a part of the sheet bundle Pb (substantially central portion in the conveyance direction) functions as a fold portion Fp (see FIG. 9). When the center-folding process, which is the process illustrated in FIGS. 6B and 6C, is executed, the folding-blade engagement roller 134 is located at the retracted position separated from the tip of the folding blade 132 that has passed the nip position, as illustrated in FIG. 6C.

Subsequently, as illustrated in FIG. 6D, the folding-blade engagement roller 134 moves from the retracted position toward the folding blade 132. At this time, the folding-blade engagement roller 134 moves to an engagement position that is a position where the folding-blade engagement roller 134 and the folding blade 132 are in contact with each other via the sheet bundle Pb. When the folding-blade engagement roller 134 moves to the engagement position, a pressed state is established in which the sheet bundle Pb is sandwiched between the folding blade 132 and the folding-blade engagement roller 134. In this pressed state, the sheet bundle Pb is pressed from both sides such that a folding-crimping teeth portion 132a including the protrusions and recesses formed on the tip of the folding blade 132 and the engaging-crimping teeth portion 134a, which is a portion including the protrusions and recesses formed on the outer peripheral surface of the cylindrical portion of the folding-blade engagement roller 134, engage with each other, so that crimp binding is performed.

With the crimp binding on the sheet bundle Pb with respect to the fold portion Fp, the sheet bundle Pb is bent in a direction opposite to the traveling direction of the folding blade 132 due to the action by the flange portions 134b included in the folding-blade engagement roller 134 and the folding blade 132. The bending position (folding position) is defined by the flange portions 134b of the folding-blade engagement roller 134. Therefore, a back portion Cb is formed on the sheet bundle Pb with the width corresponding to the distance between the flange portions 134b of the folding-blade engagement roller 134 that is opposite to the sheet bundle Pb starting from the center of the length of the sheet bundle Pb in the sheet conveyance direction.

Further, folds “f” (see FIG. 9) as folding marks are formed at respective positions of the flange portions 134b of the folding-blade engagement roller 134. The folds “f” formed at this time are formed at two positions across the back portion Cb. In other words, this process corresponds to a back-crimp binding process in which the back portion Cb is formed while forming the two folds “f” in parallel and, at the same time, or after forming the back portion Cb, the crimp binding is performed on the back portion Cb.

The flange portions 134b of the folding-blade engagement roller 134 and the folding blade 132 corresponds to the back-portion former. Further, the folding blade 132 and the folding-blade engagement roller 134 correspond to the crimp binder. Further, the folding-crimping teeth portion 132a of the folding blade 132 and the engaging-crimping teeth portion 134a of the folding-blade engagement roller 134 form streaks (crimp marks) substantially parallel to the folds “f”, in other words, a crimp mark group Ct as illustrated in FIG. 9.

In other words, in a state where the sheet bundle Pb is pressed and nipped by the folding blade 132 and the folding-blade engagement roller 134, the controller 190 causes the folding-blade engagement roller 134 to move in the width direction (main scanning direction) of the sheet bundle Pb. At the time of the moving in the width direction, the folding-blade engagement roller 134 moves while rotating. In other words, the folding-blade engagement roller 134 moves while rotating in the width direction of the sheet bundle Pb in a state where the sheet bundle Pb is pressed against the folding blade 132. At this time, the flange portions 134b of the folding-blade engagement roller 134 nip the sheet bundle Pb protruding in a thickness direction of the folding-blade engagement roller 134, in such a way as to enclose the sheet bundle Pb.

This operation causes a back portion Cb to be formed on the sheet bundle Pb, and simultaneously or after forming the back portion Cb, can perform crimp binding on the back portion Cb formed on the sheet bundle Pb. In other words, the operation described with reference to FIG. 6D is a back crimp binding process that performs a back-portion forming process (back-folding process) and a crimp binding simultaneously or successively. In this back crimp binding process, the engaging-crimping teeth portion 134a included in the folding-blade engagement roller 134 form crimp marks substantially parallel to the fold portion. The crimp marks are also substantially parallel to the folds “f”.

Finally, as illustrated in FIG. 6E, the controller 190 retracts the folding-blade engagement roller 134 in the width direction of the sheet bundle Pb, and also retracts the folding blade 132 to the retracted position. Then, the controller 190 rotates the folding roller pair 133 to convey the sheet bundle Pb so as to cause the sheet bundle Pb to pass between the folding roller pair 133, and ejects a crimp-center-bound booklet with the back portion Cb subjected to crimp binding to the center-folded booklet ejection tray 136 (see FIG. 2).

As described above, in performing the crimp center binding on the sheet bundle Pb, the post-processing apparatus 110 according to the present embodiment first performs the center-folding process, and then performs a back-folding process of forming the back portion Cb of the center-folded sheet bundle Pb. Then, at the same time, a crimp-binding process is also performed on the back portion Cb. Thus, the center biding is completed. In other words, in the crimp-center-binding method as an embodiment of the sheet processing method according to the present disclosure, the back-portion forming process is performed subsequent to the center-folding process, and at the same time, a crimp-binding process (back-portion crimp binding process) is performed on the back portion Cb. As a result, unlike the conventional method, it is possible to form a crimp-center-bound booklet that can be easily opened without causing a crimp-bound portion to be peeled off by a folding process and a page turning action.

The description above is made as an example of simultaneously performing the back-portion forming process and the crimp binding process. However, the method is not limited to the above-described method. For example, two rollers corresponding to the folding-blade engagement rollers 134 may be disposed, where one of the folding-blade engagement rollers 134 may have the engaging-crimping teeth portion 134a only and the other of the folding-blade engagement rollers 134 may have the flange portion 134b only. Due to such a configuration, the back-portion forming process and the crimp binding process can be performed in any desired order.

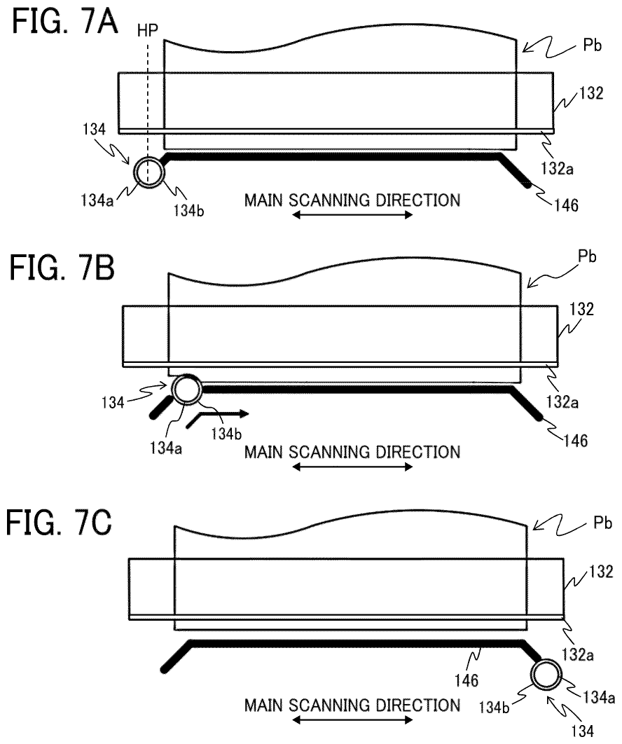

FIGS. 7A to 7C are cross-sectional views of the crimp center binder viewed from the sheet conveyance direction side at a center position of the thickness of the folding blade 132, which illustrate operation of the crimp center binder. The center position of the thickness of the folding blade 132 corresponds to a center line of center folding. The folding blade 132 has the folding-crimping teeth portion 132a as a folding-crimping teeth portion on a sheet-material pressing surface facing the folding-blade engagement roller 134 in the traveling direction. The folding-crimping teeth portion 132a is a folding-plate crimping teeth portion having a protruding-recessed shape (protruding-recessed portion).

FIG. 7A corresponds to the state illustrated in FIG. 6C. As already described, in the state illustrated in FIG. 6C, the folding blade 132 pushes the sheet bundle Pb to a position beyond the nip position of the folding roller pair 133.

When the sheet bundle Pb is pushed into the nip position of the folding roller pair 133 by the folding blade 132 and travels, the folding-blade engagement roller 134 stands by at a position on the outer side of the length in the width direction of the sheet bundle Pb formed into a booklet in the center-folding process performed on the sheet bundle Pb. The standby position at this time corresponds to the initial position (HP position). The folding-blade engagement roller 134 at the initial position (HP position) is on the outer side in the main scanning direction with respect to the sheet bundle Pb that advances while being pushed into the nip position of the folding roller pair 133. Thus, the initial position (HP position) corresponds to a position where the folding-blade engagement roller 134 is in a separated state of being separated from the sheet bundle Pb. Among the constituent elements of the folding-blade engagement roller 134, only the engaging-crimping teeth portion 134a are illustrated in FIGS. 7A to 7C.

The folding-blade engagement roller 134 (engaging-crimping teeth portion 134a) is moved in the main scanning direction (the width direction of the sheet bundle Pb) by a folding-blade-engagement-roller scanning motor 145 (see FIG. 10). The crimp center binder is provided with an engagement-roller guide rail 146 as a folding-blade-engagement-roller contacting/separating mechanism. The engaging-crimping teeth portion 134a of the folding-blade engagement roller 134 move in the main scanning direction along the engagement-roller guide rail 146.

The engagement-roller guide rail 146 is longer than the sheet bundle Pb in the main scanning direction, and portions located on the outer side of the edges of the sheet bundle Pb in the main scanning direction are separated from the fold portion of the sheet bundle Pb that has passed through the nip position of the folding roller pair 133. Furthermore, the engagement-roller guide rail 146 approaches the fold portion of the sheet bundle Pb that has passed through the nip position of the folding roller pair 133, in a portion located on the inner side of the edges of the sheet bundle Pb in the main scanning direction.

Therefore, the engaging-crimping teeth portion 134a of the folding-blade engagement roller 134 are out of contact with the fold portion formed on the sheet bundle Pb, at the edges of the sheet bundle Pb and on the outer side of the edges of the sheet bundle Pb in the main scanning direction, and move such that the engaging-crimping teeth portion 134a and the folding blade 132 nip the fold portion on the inner side of the edges in the main scanning direction. Then, the engaging-crimping teeth portion 134a move in the main scanning direction along the engagement-roller guide rail 146. As a result, points on the fold portion of the sheet bundle Pb at which the sheet bundle Pb is sandwiched between the engaging-crimping teeth portion 134a and the folding blade 132 are sequentially crimped and bound.

FIG. 7B corresponds to the state of FIG. 6D, and corresponds to a pressurized state in which the engaging-crimping teeth portion 134a of the folding-blade engagement roller 134 are pressed by the folding blade 132 to press and deform the sheet bundle Pb sandwiched between the engaging-crimping teeth portion 134a and the folding blade 132. When the folding-blade engagement roller 134 is at the fold portion of the sheet bundle Pb and scanning is performed while the back portion Cb is being formed by the folding-blade engagement roller 134, the folding roller pair 133 is in a pressurized state in which the sheet bundle Pb is nipped by the folding roller pair 133 and does not move so that the sheet bundle Pb is not pushed back. The controller 190 executes control so as to maintain the pressurized state of the folding roller pair 133. That is, when the crimp-center-binding process is performed on the sheet bundle Pb, the folding roller pair 133 is controlled in such a way as to maintain the pressurized state so that the folding blade 132 does not retract by being pressurized by the folding-blade engagement roller 134.

Then, when the folding blade 132 is pressed by the folding-blade engagement roller 134, the teeth of the engaging-crimping teeth portion 134a as an engaging crimp teeth included in the folding-blade engagement roller 134 engage with the teeth of the folding-crimping teeth portion 132a as the folding-blade crimping teeth on the pressing surface of the folding blade 132 in such a way as to nip the sheet bundle Pb. As a result, the back portion Cb of the sheet bundle Pb is pressed and deformed in the main scanning direction to execute the back-portion crimp-binding process.

The teeth of the folding-crimping teeth portion 132a are extended in the main scanning direction (see FIGS. 7A, 7B, and 7C), and the projections and recesses are arranged at given intervals in the direction (sub-scanning direction) orthogonal to the main scanning direction (see FIG. 8). When the folding-blade engagement roller 134 is moved in the main scanning direction by the folding-blade-engagement-roller scanning motor 145 (see FIG. 10), the position of engagement between the engaging-crimping teeth portion 134a of the folding-blade engagement roller 134 and the folding-crimping teeth portion 132a of the folding blade 132 moves in the main scanning direction. As the engaging position (engagement position) moves, the crimp-binding process is performed on the back portion Cb of the sheet bundle Pb. While the crimp-binding process is being performed, the folding roller pair 133 is kept pressed toward the nip position so that the folding-blade engagement roller 134 can reciprocate in the main scanning direction while maintaining the engagement position. This prevents the sheet bundle Pb and the folding blade 132 from escaping by being pressed by the folding-blade engagement roller 134.

As described above, when the engaging-crimping teeth portion 134a of the folding-blade engagement roller 134 approach the back portion Cb formed on the sheet bundle Pb, the engaging-crimping teeth portion 134a move in an oblique direction from the outer side in the width direction of the sheet bundle Pb toward the back portion Cb. As a result, the engaging-crimping teeth portion 134a of the folding-blade engagement roller 134 approach from a direction in which the engaging-crimping teeth portion 134a do not collide with a width-directional end of the back portion Cb of the sheet bundle Pb, and the position of engagement with the folding-crimping teeth portion 132a of the folding blade 132 starts from the inner side of a width-directional edge of the sheet bundle Pb. As a result, the edge of the sheet bundle Pb can be prevented from being turned up when the folding-blade engagement roller 134 passes through the edge.

As illustrated in FIG. 7C, after the crimp binding is performed on the back portion Cb of the sheet bundle Pb, the engaging-crimping teeth portion 134a passes to a position on the outer side of the other width-directional edge of the sheet bundle Pb in the main scanning direction (the edge opposite to the standby position HP), and moves to a position separated from the folding-crimping teeth portion 132a in a center-folding ejection direction.

When the crimp-center-binding operation is successively performed on a next sheet bundle Pb, the engaging-crimping teeth portion 134a move in a reverse direction in the main scanning direction. In other words, the engaging-crimping teeth portion 134a move from left to right for an odd-numbered sheet bundle Pb in FIG. 7B, and the engaging-crimping teeth portion 134a move from right to left for an even-numbered sheet bundle Pb in FIG. 7B.

The folding-blade-engagement-roller contacting-separating mechanism according to the present embodiment has been exemplified by the configuration including the engagement-roller guide rail 146 and the folding-blade-engagement-roller scanning motor 145 (see FIG. 10), but the mechanism is not limited thereto. A moving motor may be further provided which moves the folding-blade engagement roller 134 such that the folding-blade engagement roller 134 can advance and retract in the center-folding ejection direction.

FIG. 8 is a schematic diagram illustrating a state of the sheet bundle Pb being pressed by the crimp center binder.

As illustrated in FIG. 8, the folding blade 132 corresponds to a folding plate member that guides the center area in the conveyance direction of the sheet bundle Pb stacked in layer on the inner tray 114 in the direction to the nip position of the folding roller pair 133. Further, the folding roller pair 133 corresponds to a folding roller pair that nips the sheet bundle Pb that is guided by the folding blade 132 to advance toward the nip position and cause the sheet bundle Pb to further advance in the advancing direction of the sheet bundle Pb while nipping the sheet bundle Pb.

In other words, the folding roller pair 133 is biased at the nip position, by the folding-roller-pair pressurizing member 144, toward the folding blade 132 so as to nip the sheet bundle Pb with the folding blade 132. Due to the configuration in which the folding roller pair 133 is biased toward the folding blade 132, the folding roller pair 133 presses the folding blade 132 that passes the nip position. The folding-roller-pair pressurizing member 144 is an elastic member such as a spring. Due to such a configuration, the folding-roller-pair pressurizing member 144 can be pushed back by elasticity while pressing the folding roller pair 133 toward the folding blade 132 when the folding blade 132 and the sheet bundle Pb travel between the folding roller pair 133 (the nip position).

In the states of FIGS. 6B and 6C, the folding roller pair 133 conveys the sheet bundle Pb while pressing the sheet bundle Pb toward the folding blade 132. Therefore, the fold portion is pushed by a traveling-direction end of the folding blade 132 while the sheet bundle Pb is passing between the folding roller pair 133. Thus, the folding process is performed on the sheet bundle Pb. In addition, in the state of FIG. 6D, at the time of crimp binding, the sheet bundle Pb is held by the folding-blade engagement roller 134 in a state where the folding roller pair 133 presses the sheet bundle Pb.

The folding-blade engagement roller 134 is pressed by a folding-blade-engagement-roller pressurizing member 147 toward the folding blade 132 with the sheet bundle Pb interposed between the folding-blade engagement roller 134 and the folding blade 132. By use of this pressing force, crimp binding is performed by the engaging-crimping teeth portion 134a of the folding-blade engagement roller 134. Then, when being pressed toward the folding blade 132 by the engaging-crimping teeth portion 134a, portions of the sheet bundle Pb sandwiched between thickness-directional ends of the folding blade 132 and the flange portions 134b are directed in a direction along the folding blade 132. As a result, the portion of the sheet bundle Pb sandwiched between each flange portion 134b and the folding blade 132 is bent. This bending direction is opposite to a direction in which the folding blade 132 advances. At this time, a bent portion is formed at two positions spaced at a predetermined interval in the thickness direction of the folding blade 132. Thus, a square back is formed on the sheet bundle Pb by the crimp-center-binding operation. In other words, square-back folding is executed by the back-portion crimp-binding process.

If the trace of the engaging-crimping teeth portion 134a is orthogonal to the main scanning direction when the folding-blade engagement roller 134 described above performs the crimp-binding process while performing scanning in the main scanning direction, a pressurization point sequentially moves while making line contact to perform crimp binding. In this case, crushing force acts more strongly at the pressurization point than the stretching of the sheet bundle Pb. Meanwhile, when the trace of the engaging-crimping teeth portion 134a is parallel to the main scanning direction as in the present embodiment, the upper crimping teeth 177 can be pressed against the lower crimping teeth 178 in parallel to the main scanning direction as described with reference to FIGS. 4A and 4B. As a result, at the binding position where the crimping binding has been performed, the sheets P can be locally stretched and entangled with each other to achieve stronger crimp binding.

### Booklet Bk

FIG. 9 is a perspective view of a booklet Bk that exemplifies a booklet to be formed by the above-described crimp-center-binding operation. As illustrated in FIG. 9, the sheet bundle Pb is bent at the fold portion Fp in the center-folding process performed on the sheet bundle Pb. Thus, the booklet Bk is formed, and a square back is formed on the back portion Cb. The Crimp mark group Ct is formed on the back portion Cb at predetermined intervals in a direction orthogonal to a longitudinal direction of the back portion Cb. The crimp mark group Ct is made as a result of pressure deformation by the engaging-crimping teeth portion 134a and the folding blade 132. The crimp mark group Ct can be formed at a position overlapping the position (fold portion Fp) where the sheet bundle Pb has been folded in the center-folding process performed on the sheet bundle Pb. In the booklet Bk, portions that move when the page turning action is performed correspond to the two folds “f” forming the back portion Cb. The two folds “f” are formed near both sides of the crimp marks Ct.

Therefore, the booklet Bk to be formed in the crimp-center binding process according to the present embodiment has a structure to prevent a load from being applied to a crimped portion when a page turning action is made to turn a page at the folds “f”, and thus, has a structure in which a bound portion is not peeled off by the page turning action. In addition, since the folds “f” are formed at two positions with the back portion Cb interposed therebetween, either of the folds “f” formed at the two positions is movable in the page turning action. The fold “f” is at a position not overlapping with the fold portion Fp pushed into the nip position of the folding roller pair 133 by the folding blade 132. The fold portion Fp is at a binding position of the crimp-binding process.

Therefore, when page turning actions are performed, pages are turned at the folds “f”, and the fold portion Fp corresponding to a central portion of an opened booklet Bk is in a bound state. Therefore, no page is turned across the binding position. That is, since center-folding lines (folds “f”) are disposed symmetrically on both sides of the binding position, a double-page spread can be evenly formed. Thus, the quality of the booklet Bk is also maintained.

### Control Configuration

FIG. 10 is a hardware configuration diagram of the controller 190 that controls operation of the post-processing apparatus 110 according to the first embodiment. As illustrated in FIG. 10, the controller 190 has a configuration in which a central processing unit (CPU) 11, a random access memory (RAM) 12, a read only memory (ROM) 13, a hard disk drive (HDD) 14, and an interface (I/F) 15 are connected via a common bus 16.

The CPU 11 is an arithmetic unit, and controls the entire operation of the post-processing apparatus 110. The RAM 12 is a volatile storage medium that allows information to be read and written at a high speed, and is used as a work area when the CPU 11 processes information. The ROM 13 is a read-only nonvolatile storage medium, and stores programs such as firmware. The HDD 14 is a nonvolatile storage medium that has a large storage capacity, and allows the reading and writing of information. An operating system (OS), various control programs, application programs, and the like are stored in the HDD 14.

The post-processing apparatus 110 processes, for example, a control program stored in the ROM 13 and an information processing program (application program) loaded from a storage medium such as the HDD 14 into the RAM 12, by an arithmetic function of the CPU 11. The processing implements a software control unit including various functional modules of the post-processing apparatus 110. A combination of the software control unit configured in this manner and hardware resources mounted on the post-processing apparatus 110 forms functional blocks that implement the function of the post-processing apparatus 110. That is, the CPU 11, the RAM 12, the ROM 13, and the HDD 14 form the controller 190 (control unit) that controls operation of the post-processing apparatus 110.

The I/F 15 is an interface that connects, to the common bus 16, the first conveyance roller pair 111, the second conveyance roller pair 112, the return conveyance roller 113, the side fences 116, the ejection roller pair 119, the movable end fence 131, the folding-blade movement motor 141, the folding-roller-pair rotation motor 142, the folding-roller-pair movement motor 143, the folding-blade-engagement-roller scanning motor 145, the staple-edge-binding main scanning motor 161, the staple-edge-binding posture rotation motor 164, the staple-edge-binding clinch motor 166, the crimp-edge-binding main scanning motor 171, the crimp-edge-binding posture rotation motor 174, the crimp-edge-binding clinch motor 176, the binding-teeth slide motor 179, a crimp-roller movement motor 188, and the operation panel 102.

The controller 190 causes the first conveyance roller pair 111, the second conveyance roller pair 112, the return conveyance roller 113, the side fences 116, the ejection roller pair 119, the movable end fence 131, the folding-blade movement motor 141, the folding-roller-pair rotation motor 142, the folding-roller-pair movement motor 143, the folding-blade-engagement-roller scanning motor 145, the staple-edge-binding main scanning motor 161, the staple-edge-binding posture rotation motor 164, the staple-edge-binding clinch motor 166, the crimp-edge-binding main scanning motor 171, the crimp-edge-binding posture rotation motor 174, the crimp-edge-binding clinch motor 176, the binding-teeth slide motor 179, and the crimp-roller movement motor 188 to operate, through the I/F 15.

As already described with reference to FIG. 1, the image forming apparatus 101 includes the operation panel 102. The operation panel 102 includes an operation device and a display (notification unit). The operation device receives an input operation from a user. The display notifies the user of information. The operation device includes, for example, physical input buttons and a touch screen overlaid on a display. Then, the operation panel 102 acquires information from the user through the operation device, and provides information to the user through the display. A specific example of the notification unit is not limited to the display and may be a light emitting diode (LED) lamp or a speaker. The post-processing apparatus 110 may include the same operation panel 102 as described above.

### First Modification

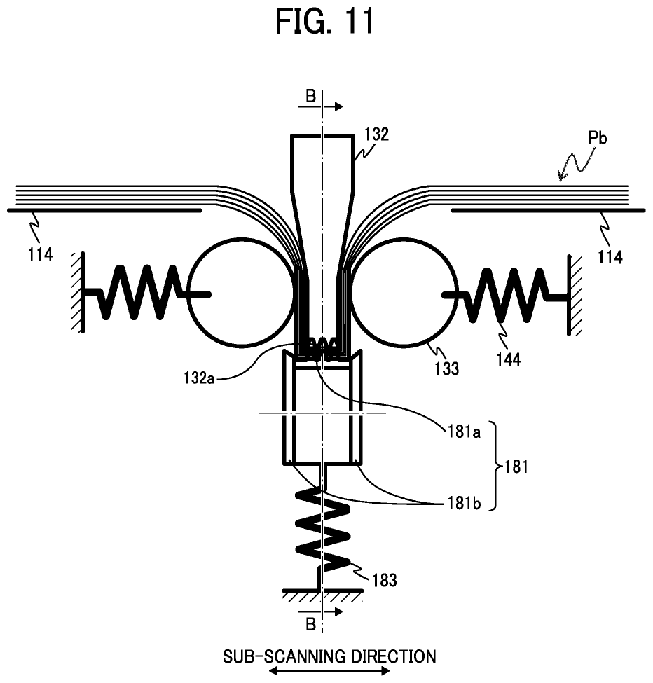

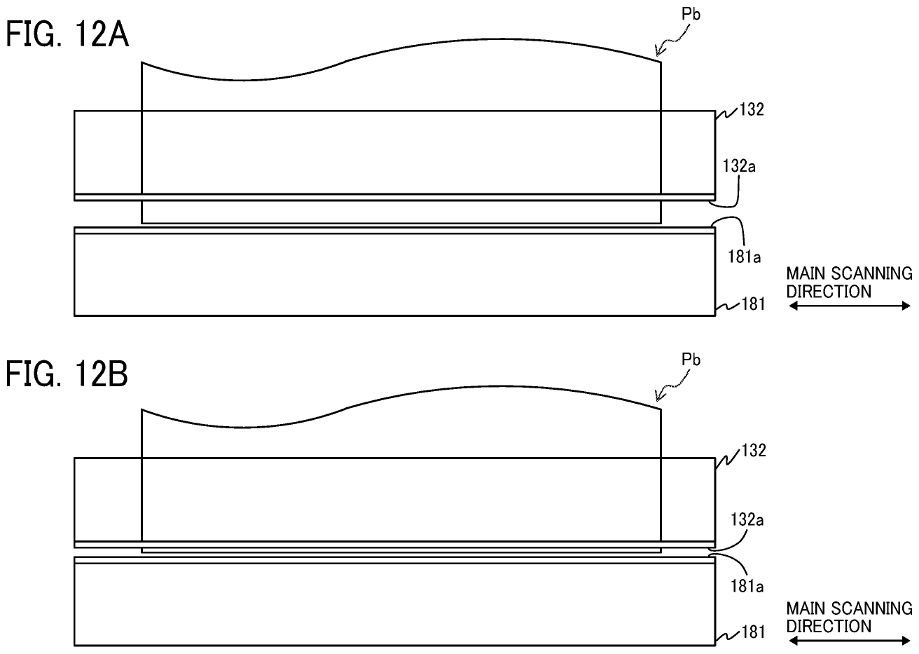

Next, a first modification of the crimp center binder will be described with reference to FIGS. 11, 12A, and 12B. A crimp center binder according to the first modification differs from the crimp center binder according to the first embodiment in that a member to be used at the time of performing crimp binding on the back portion Cb formed after the center-folding process is performed on the sheet bundle Pb is not a roller member such as the folding-blade engagement roller 134 but a blade member extending in the longitudinal direction of the back portion Cb. That is, in the first modification, a folding-blade engagement die 181 is provided as a member to be engaged with the folding blade 132 so as to crimp and bind the back portion Cb. Note that constituent elements common to the crimp center binders according to the present modification and the first embodiment are denoted by the same reference numerals, and detailed description thereof will be omitted.

FIG. 11 is a schematic diagram illustrating the first modification of the crimp center binder. The folding roller pair 133 is pressed against each other by the folding-roller-pair pressurizing member 144 while nipping the folding blade 132 and the sheet bundle Pb.

The folding-blade engagement die 181 has protrusions and recesses as a plurality of engaging-crimping tooth groups on a surface facing the folding blade 132. The plurality of engaging-crimping tooth groups extends in a direction parallel to the longitudinal direction. The folding blade 132 includes the folding-crimping teeth portion 132a on a surface facing the folding-blade engagement die 181. The folding-crimping teeth portion 132a functions as a folding-plate crimping tooth group to be engaged with the engaging-crimping tooth groups. When the folding blade 132 pushes the sheet bundle Pb into the folding roller pair 133 and the fold of the sheet bundle Pb reaches a position where the folding blade 132 and the folding-blade engagement die 181 can engage with each other, the folding-blade engagement die 181 moves toward the folding blade 132 and presses the folding blade 132 to perform crimp binding. At this time, the folding roller pair 133 is pressed toward the folding blade 132 by the folding-roller-pair pressurizing member 183. Thus, the folding blade 132 is prevented from being pushed back by being pressed by the folding-blade engagement die 181. The pressing force of the folding-blade engagement die 181 causes a crimping portion 181a of the folding-blade engagement die 181 to perform crimp binding. As a result, multiple crimp marks are formed on the back portion Cb by the plurality of protrusions and recesses in a direction parallel to the longitudinal direction of the back portion Cb. The crimp marks are also substantially parallel to the folds “f”. Furthermore, the pressing force of the folding-blade engagement die 181 allows flange portions 181b of the folding-blade engagement die 181 to perform square-back folding on the sheet bundle Pb.

FIGS. 12A and 12B are cross-sectional views of the crimp center binder according to the first modification, which illustrate operation of the crimp center binder. FIGS. 12A and 12B are cross-sectional views of the crimp center binder taken along line B-B as viewed from the sheet conveyance direction side at the center line of center folding, that is, at the center position of the thickness of the folding blade 132. FIG. 12A corresponds to the state of FIG. 6C. The folding blade 132 has pushed the sheet bundle Pb to a position beyond the nip position of the folding roller pair 133. The folding-blade engagement die 181 is located at the standby position (HP position), and is separated from the sheet bundle Pb in the center-folding ejection direction.

The folding-blade engagement die 181 is moved toward the folding blade by a folding-blade-engagement-die movement motor 182 (see FIG. 10).

FIG. 12B corresponds to the state of FIG. 6D. The folding-blade engagement die 181 is pressed against the folding blade 132 with the sheet bundle Pb interposed therebetween. Thus, the teeth of the crimping portion 181a of the folding-blade engagement die 181 and the folding-crimping teeth portion 132a provided on the pushing surface of the folding blade 132 are engaged with each other with the sheet bundle Pb interposed therebetween. When the folding-blade engagement die 181 is pressurized by a folding-blade-engagement-die pressurizing member 183, the back portion of the sheet bundle Pb is crimped and bound.

### Second Modification

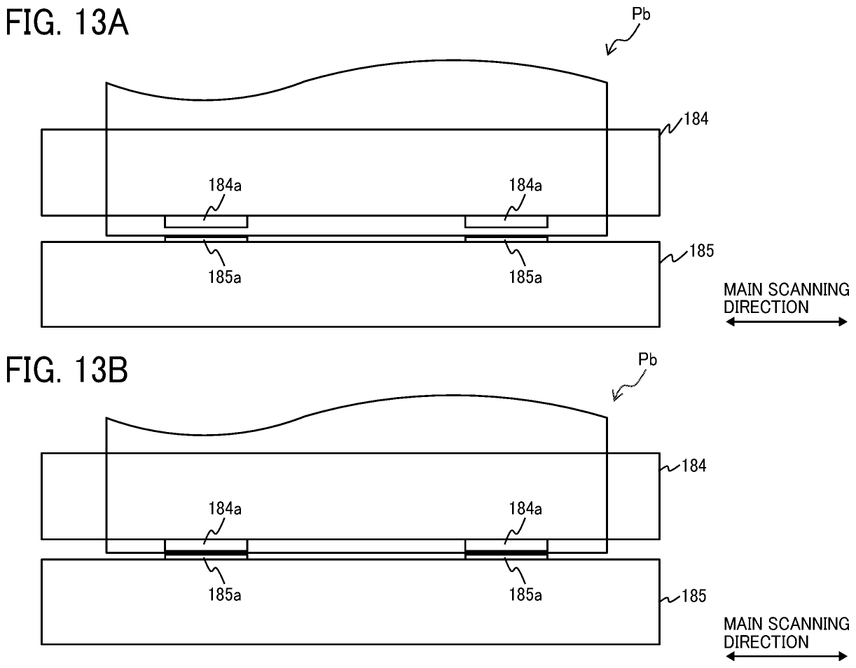

Next, a second modification of the crimp center binder will be described with reference to FIGS. 13A and 13B. A crimp center binder according to the second modification differs from the crimp center binder according to the first modification in that crimping teeth in a protruding-recessed shape (protruding-recessed portion) are not uniformly disposed in the width direction but partially (intermittently) disposed. Note that constituent elements common to the crimp center binders according to the present modification and the first embodiment are denoted by the same reference numerals, and detailed description thereof will be omitted.

FIGS. 13A and 13B are cross-sectional views of the crimp center binder according to the second modification, which illustrate operation of the crimp center binder. FIGS. 13A and 13B are cross-sectional views of the crimp center binder according to the second modification viewed from the sheet conveyance direction side at the center line of center folding, that is, at the center position of the thickness of the folding blade 184. FIG. 13A corresponds to the state of FIG. 6C. A folding blade 184 has pushed the sheet bundle Pb to a position beyond the nip position of the folding roller pair 133. A folding-blade engagement die 185 is located at the standby position (HP position), and is separated from the sheet bundle Pb in the center-folding ejection direction.

The folding-blade engagement die 185 is moved toward the folding blade 184 by the folding-blade-engagement-die movement motor 182 (see FIG. 10).

FIG. 13B corresponds to the state of FIG. 6D. The folding-blade engagement die 185 is pressed against the folding blade 184 with the sheet bundle Pb interposed therebetween. Thus, the teeth of a crimping portion 185a of the folding-blade engagement die 185 and the teeth of a crimping-teeth portion 184a provided on a pushing surface of the folding blade 184 are engaged with each other with the sheet bundle Pb interposed therebetween. When the folding-blade engagement die 185 is pressurized by the folding-blade-engagement-die pressurizing member 183, the back portion of the sheet bundle Pb is crimped and bound.

### Third Modification

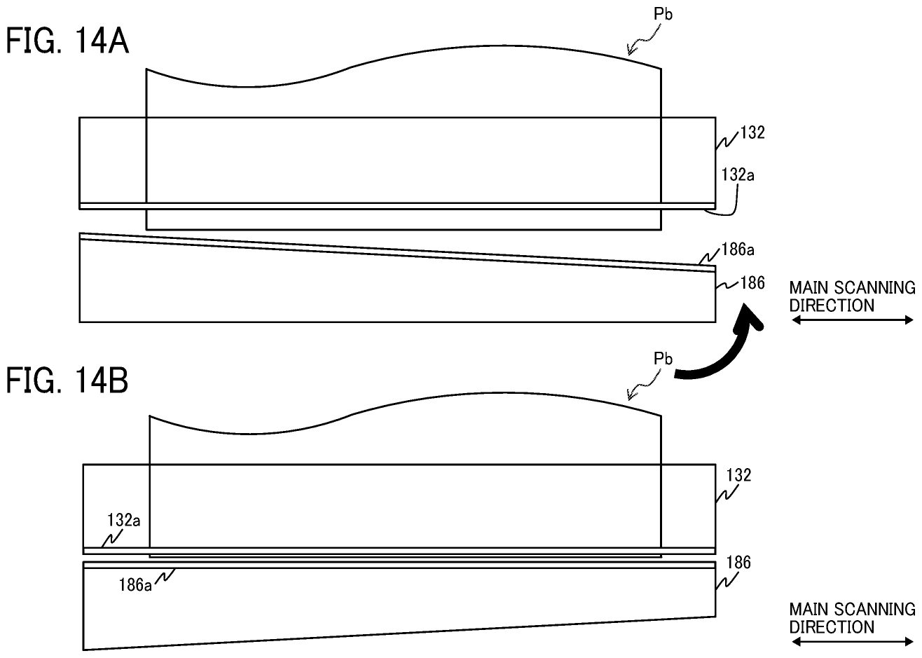

Next, a third modification of the crimp center binder will be described with reference to FIGS. 14A and 14B. A crimp center binder according to the third modification differs from the crimp center binder according to the first modification in that a folding-blade engagement member (a folding-blade engagement die 186) is configured such that the folding-blade engagement member does not linearly move to and engage with the folding blade 132 while facing the folding blade 132, but moves on a rotational trajectory so that crimping teeth in a protruding-recessed shape (protruding-recessed portion) sequentially engage with each other. Note that constituent elements common to the crimp center binders according to the present modification and the first embodiment are denoted by the same reference numerals, and detailed description thereof will be omitted.

FIGS. 14A and 14B are cross-sectional views of the crimp center binder according to the third modification, which illustrate operation of the crimp center binder. FIGS. 14A and 14B are cross-sectional views of the crimp center binder according to the third modification viewed from the sheet conveyance direction side at the center line of center folding, that is, at the center position of the thickness of the folding blade 132. FIG. 14A corresponds to the state of FIG. 6C. The folding blade 132 has pushed the sheet bundle Pb to a position beyond the nip position of the folding roller pair 133. The folding-blade engagement die 186 is located at the standby position (HP position), and is separated from the sheet bundle Pb in the center-folding ejection direction.

The folding-blade engagement die 186 is moved toward the folding blade by the folding-blade-engagement-die movement motor 182 (see FIG. 10), and the folding-blade engagement die 186 is moved on a rotational trajectory so that the teeth of the crimping portion 186a of the folding-blade engagement die 186 sequentially engage with the teeth of the folding-crimping teeth portion 132a of the folding blade 132.

FIG. 14B corresponds to the state of FIG. 6D. The folding-blade engagement die 186 is pressed against the folding blade 132 with the sheet bundle Pb interposed therebetween. Thus, the teeth of a crimping portion 186a of the folding-blade engagement die and the folding-crimping teeth portion 132a provided on the pushing surface of the folding blade 132 are engaged with each other with the sheet bundle Pb interposed therebetween. When the folding-blade engagement die 186 is pressurized by the folding-blade-engagement-die pressurizing member 183, the back portion of the sheet bundle Pb is crimped and bound.

The crimping portion 186a of the folding-blade engagement die 186 is not a flat surface but a curved surface. Thus, the teeth of the crimping portion 186a may be provided on the curved surface, and the crimping portion 186a of the folding-blade engagement die 186 may be moved on a rotational trajectory so that the teeth of the crimping portion 186a of the folding-blade engagement die 186 sequentially engage with the teeth of the folding-crimping teeth portion 132a of the folding blade 132.

As described above, the teeth of the crimping portion 186a of the folding-blade engagement die 186 sequentially engage with the teeth of the folding-crimping teeth portion 132a of the folding blade 132. As a result, the pressurizing force to be applied at the time of crimp binding can be reduced, and thus, the apparatus can be downsized.

### Fourth Modification

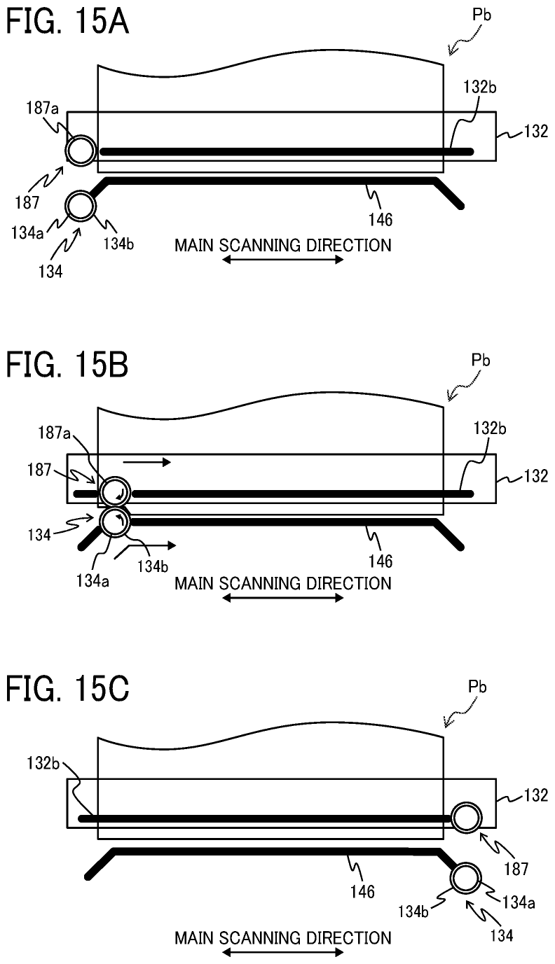

Next, a fourth modification of the crimp center binder will be described with reference to FIGS. 15A to 15C. A crimp center binder according to the fourth modification differs from the crimp center binder according to the first embodiment in that the folding blade 132 includes a crimp roller 187 having teeth disposed on an outer periphery to be movable at a tip portion in the main scanning direction. Note that constituent elements common to the crimp center binders according to the present modification and the first embodiment are denoted by the same reference numerals, and detailed description thereof will be omitted.

FIGS. 15A to 15C are cross-sectional views of the crimp center binder according to the fourth modification, which illustrate operation of the crimp center binder. FIGS. 15A to 15C are cross-sectional views of the crimp center binder according to the fourth modification viewed from the sheet conveyance direction side at the center line of center folding, that is, at the center position of the thickness of the folding blade 132. FIG. 15A corresponds to the state of FIG. 6C. The folding blade 132 has pushed the sheet bundle Pb to a position beyond the nip position of the folding roller pair 133. The folding-blade engagement roller 134 and the crimp roller 187 are located at the standby position (HP position), and are separated from the sheet bundle Pb in the center-folding ejection direction.

The crimp roller 187 functioning as a first roller member is supported in such a way as to be guided by a crimp-roller rail 132b. The crimp-roller rail 132b is disposed in a longitudinal direction (main scanning direction) of the folding blade 132. The crimp roller 187 is moved in the main scanning direction of the sheet bundle Pb by the crimp-roller movement motor 188 (see FIG. 10).

FIG. 15B corresponds to the state of FIG. 6D. The folding-blade engagement roller 134 functioning as a second roller member is guided by the engagement-roller guide rail 146, approaches the crimp roller 187, and is pressed against the crimp roller 187 via the sheet bundle Pb. The teeth of the engaging-crimping teeth portion 134a of the folding-blade engagement roller 134 and the teeth of a crimping portion 187a provided on a pushing surface of the crimp roller 187 are engaged with each other with the sheet bundle Pb interposed therebetween. At this time, the folding-blade engagement roller 134 is pressed by the folding-blade-engagement-roller pressurizing member 147.

As a result, the teeth of the engaging-crimping teeth portion 134a of the folding-blade engagement roller 134 and the teeth of a crimping portion 187a provided on a pushing surface of the crimp roller 187 press and deform the sheet bundle Pb to crimp and bind the back portion Cb of the sheet bundle Pb.

### Fifth Modification

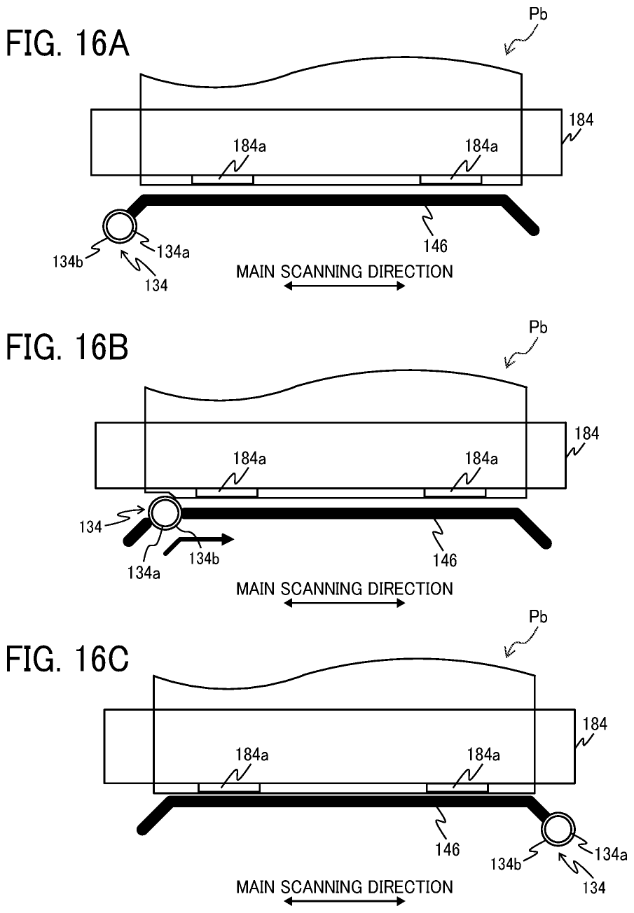

Next, a fifth modification of the crimp center binder will be described with reference to FIGS. 16A to 16C. A crimp center binder according to the fifth modification differs from the crimp center binder according to the first embodiment in that the crimping teeth of the folding blade in a protruding-recessed shape (protruding-recessed portion) are not uniformly disposed in the main scanning direction, but are partially (intermittently) disposed. Note that constituent elements common to the crimp center binders according to the present modification and the first embodiment are denoted by the same reference numerals, and detailed description thereof will be omitted.

FIGS. 16A to 16C are cross-sectional views of the crimp center binder according to the fifth modification, which illustrate operation of the crimp center binder. FIGS. 16A to 16C are cross-sectional views of the crimp center binder according to the fifth modification viewed from the sheet conveyance direction side at the center line of center folding, that is, at the center position of the thickness of the folding blade 184. FIG. 16A corresponds to the state of FIG. 6C. The folding blade 184 has pushed the sheet bundle Pb to a position beyond the nip position of the folding roller pair 133. The folding-blade engagement roller 134 is located at the standby position (HP position), and is separated from the sheet bundle Pb in the center-folding ejection direction.

FIG. 16B corresponds to the state of FIG. 6D. The folding-blade engagement roller 134 is pressed against the folding blade 184 with the sheet bundle Pb interposed therebetween. Thus, the teeth of the crimping-teeth portion 184a provided on the pushing surface of the folding blade 184 and the teeth of the engaging-crimping teeth portion 134a of the folding-blade engagement roller 134 are engaged with each other with the sheet bundle Pb interposed therebetween. At this time, the folding-blade engagement roller 134 is pressed by the folding-blade-engagement-roller pressurizing member 147.

As a result, the teeth of the engaging-crimping teeth portion 134a of the folding-blade engagement roller 134 and the teeth of the crimping-teeth portion 184a of the folding blade 184 press and deform the sheet bundle Pb to crimp and bind the back portion Cb of the sheet bundle Pb.

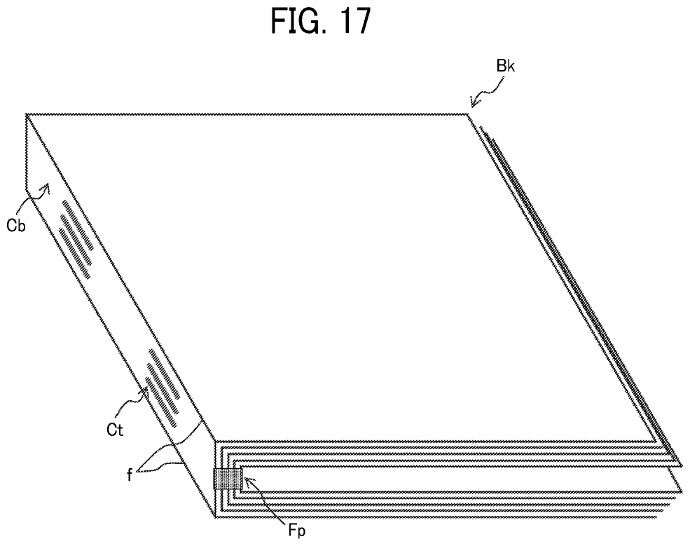

FIG. 17 is a schematic view of a booklet Bk formed in the fifth modification. As illustrated in FIG. 17, the back portion Cb of the booklet Bk has a square back. Then, the back portion Cb is intermittently crimped and bound, and the crimp mark group Ct is intermittently formed in the longitudinal direction of the back portion Cb (width direction of the sheet bundle Pb).

### Sixth Modification

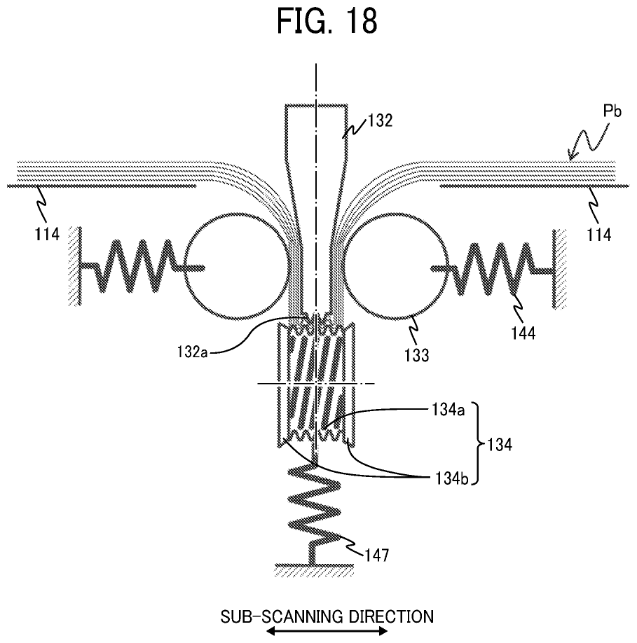

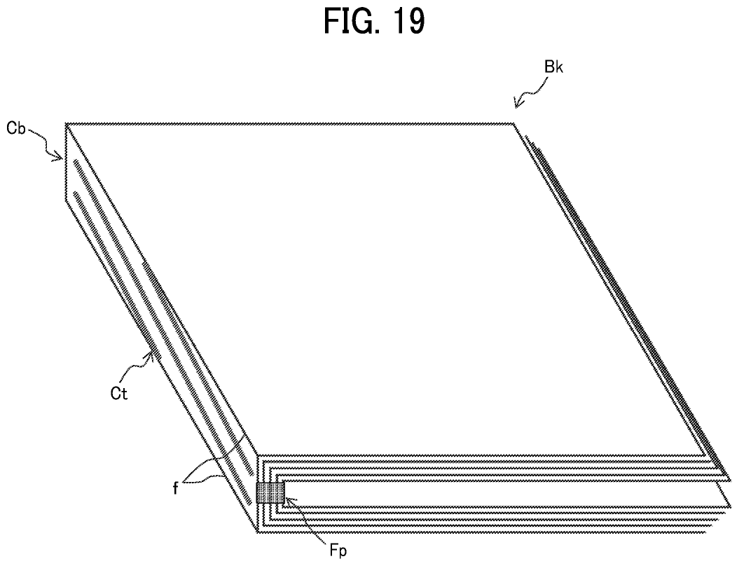

Next, a sixth modification of the crimp center binder will be described with reference to FIGS. 18 and 19. A crimp center binder according to the sixth modification differs from the crimp center binder according to the first embodiment in that the teeth of the engaging-crimping teeth portion 134a of the folding-blade engagement roller 134 are not aligned in parallel to the sub-scanning direction, but are formed in, for example, a “helical-tooth shape” aligned and inclined with respect to the sub-scanning direction. The teeth of the engaging-crimping teeth portion 134a are inclined at an angle of, for example, 15 degrees. The constituent elements common to the crimp center binders according to the present modification and the first embodiment are denoted by the same reference numerals, and detailed description thereof will be omitted.

FIG. 19 is a schematic view of a crimp-center-bound booklet bound in the sixth modification. As illustrated in FIG. 19, the back portion Cb of the booklet Bk has a square back. Then, the back portion Cb is crimped and bound, and the crimp mark group Ct is aligned and inclined in the lateral direction of the back portion Cb (the thickness direction of the sheet bundle Pb).

### Seventh Modification

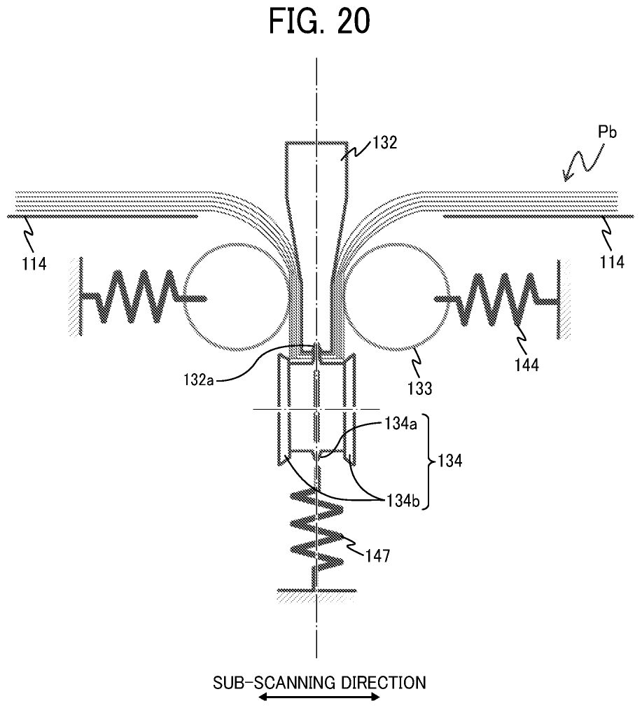

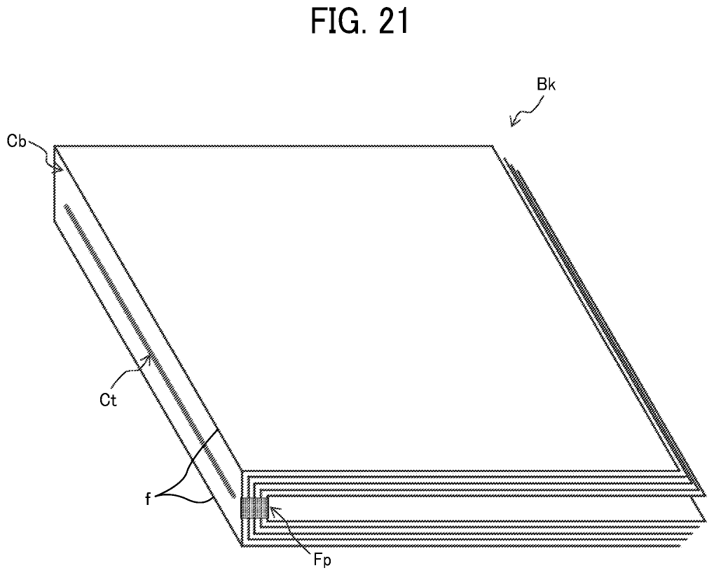

A seventh modification of the crimp center binder will be described with reference to FIGS. 20 and 21. A crimp center binder according to the seventh modification differs from the crimp center binder according to the first embodiment in that a plurality of engaging-crimping teeth portions 134a of the folding-blade engagement roller 134 is not arranged in a sub-scanning direction, but the engaging-crimping teeth portion 134a of the folding-blade engagement roller 134 includes a single projection, and that the folding blade 132 includes a single groove on the pushing surface of the folding blade 132 to mesh with the single projection of the engaging-crimping teeth portion 134a of the folding-blade engagement roller 134. The constituent elements common to the crimp center binders according to the present modification and the first embodiment are denoted by the same reference numerals, and detailed description thereof will be omitted.

FIG. 21 is a schematic view of a booklet Bk created by the crimp-binding process performed by the crimp center binder according to the seventh modification. As illustrated in FIG. 21, a square back is formed on the back portion Cb of the booklet Bk, and the crimp mark group Ct is formed as a single crimp mark in the longitudinal direction of the square back. The crimp mark group Ct is a single mark extending in the main scanning direction, and is formed substantially parallel to the folds “f”.

### Eighth Modification

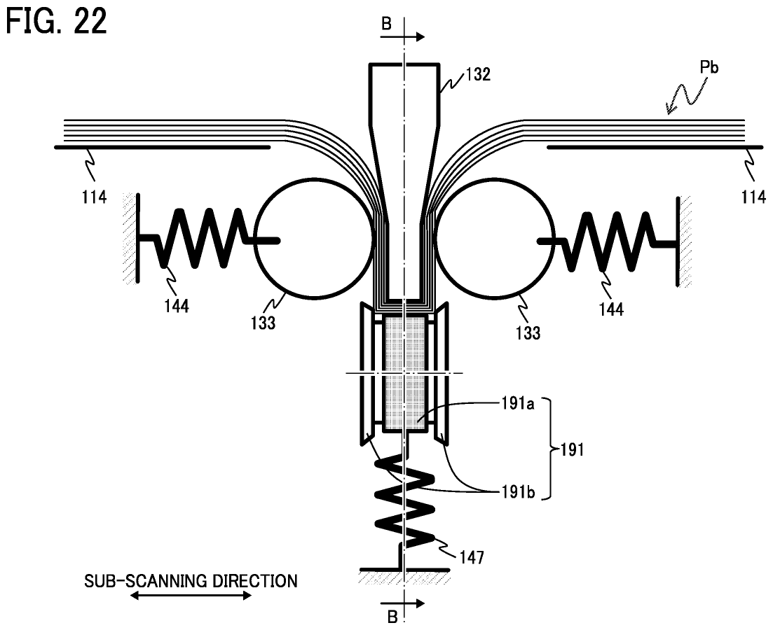

Next, an eighth modification of the crimp center binder will be described with reference to FIG. 22. A crimp center binder according to the eighth modification differs from the crimp center binder according to the first embodiment in that no crimping-teeth portion having a protruding-recessed shape (protruding-recessed portion) is provided on the pushing surface of the folding blade 132, no crimping-teeth portion having a protruding-recessed shape (protruding-recessed portion) is provided on the cylindrical outer peripheral portion of the folding-blade engagement roller, and instead, a reheating unit is provided on the cylindrical outer peripheral portion of a folding-blade engagement roller 191. Note that constituent elements common to the crimp center binders according to the present modification and the first embodiment are denoted by the same reference numerals, and detailed description thereof will be omitted.

FIG. 22 is a schematic diagram illustrating the eighth modification of the crimp center binder. The folding roller pair 133 is pressed against each other by the folding-roller-pair pressurizing member 144 while nipping the folding blade 132 and the sheet bundle Pb.

Furthermore, the folding-blade engagement roller 191 functioning as a folding-plate-engagement heating member according to the present modification is pressed by the folding-blade-engagement-roller pressurizing member 147 toward the folding blade 132 with the sheet bundle Pb interposed between the folding-blade engagement roller 191 and the folding blade 132. By use of the pressing force and the heat, toner-crimp binding is performed by a heat-crimping portion 191a of the folding-blade engagement roller 191. Then, the back-portion forming process of performing square-back folding on the sheet bundle Pb can be performed by flange portions 191b formed at both ends of a cylindrical portion of the folding-blade engagement roller 191.

The folding-blade engagement roller 191 forming a toner crimp binder is a cylindrical roller-shaped member. A rotation axis of the folding-blade engagement roller 191 is set in a direction passing through both ends sandwiching the cylindrical outer peripheral portion of the folding-blade engagement roller 191. The folding-blade engagement roller 191 is pivotally supported such that the folding-blade engagement roller 191 can rotate about the rotation axis as a rotation center. The folding-blade engagement roller 191 includes the heat-crimping portion 191a on the cylindrical outer peripheral portion (cylindrical outer peripheral surface). The folding-blade engagement roller 191 also includes the flange portions 191b having an outer diameter larger than the outer diameter of the heat-crimping portion 191a at both ends of the cylindrical outer peripheral surface. The flange portions 191b are equal in diameter at both ends of the cylindrical outer peripheral surface.

The heat-crimping portion 191a of the folding-blade engagement roller 191 is a portion heated by a heater installed inside the folding-blade engagement roller 191.

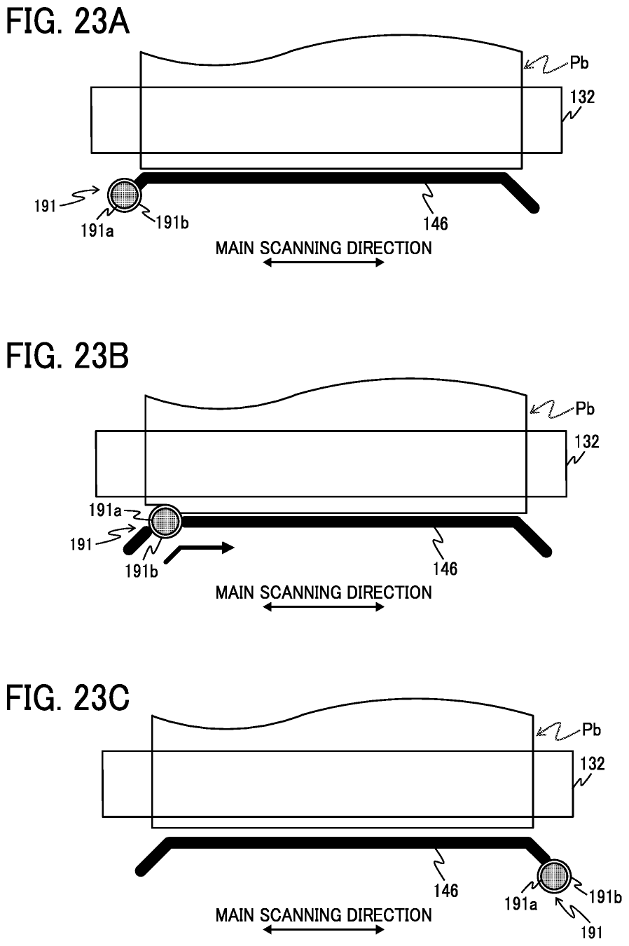

FIGS. 23A to 23C are cross-sectional views of the crimp center binder according to the eighth modification, which illustrate operation of the crimp center binder. FIGS. 23A to 23C are cross-sectional views of the crimp center binder taken along line B-B in FIG. 22, as viewed from the sheet conveyance direction side at the center line of center folding, that is, at the center position of the thickness of the folding blade 132. FIG. 23A corresponds to the state of FIG. 6C. The folding blade 132 has pushed the sheet bundle Pb to a position beyond the nip position of the folding roller pair 133. The folding-blade engagement roller 191 is located at the standby position (HP position), and is separated from the sheet bundle Pb in the center-folding ejection direction.

The folding-blade engagement roller 191 (heat-crimping portion 191a) is moved in the main scanning direction (width direction) by the folding-blade-engagement-roller scanning motor 145 (see FIG. 10). The crimp center binder is provided with the engagement-roller guide rail 146 as a folding-blade-engagement-roller contacting/separating mechanism. The folding-blade engagement roller 191 moves in the main scanning direction along the engagement-roller guide rail 146.

FIG. 23B corresponds to the state of FIG. 6D. The folding-blade engagement roller 191 is pressed against the folding blade 132 with the sheet bundle Pb interposed therebetween, and the heat-crimping portion 191a of the folding-blade engagement roller 191 is pressed against the pushing surface of the folding blade 132 to be heated and pressurized with the sheet bundle Pb interposed therebetween. As a result, the back portion Cb of the sheet bundle Pb is crimped and bound.

FIG. 23C illustrates a state in which the folding-blade engagement roller 191 crimps and binds the entire region in the longitudinal direction of the back portion Cb of the sheet bundle Pb is crimped and bound in the longitudinal direction, and then the folding-blade engagement roller 191 is separated from the sheet bundle Pb in the center-folding ejection direction.

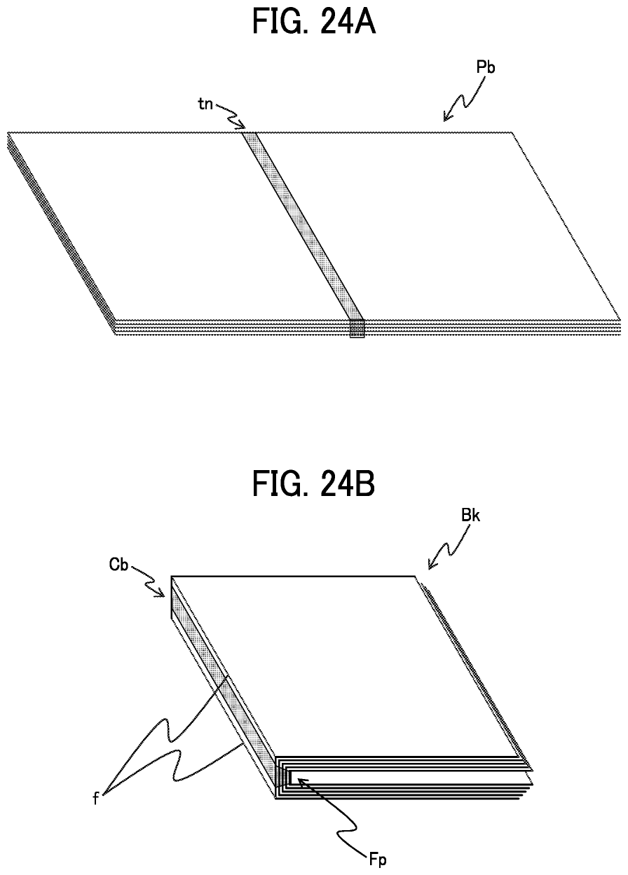

FIG. 24A is a schematic view of the sheet bundle Pb that has yet to be subjected to the crimp center binding (including the center folding and the crimp binding) in the eighth modification. FIG. 24A corresponds to the state of FIG. 6A. As illustrated in FIG. 24A, a toner image “tn” is formed at a position corresponding to a fold portion of the booklet Bk by the image forming apparatus 101 using toner for forming a visible image, for adhesion. The toner image corresponds to an adhesive medium formed on an adhesive portion of the sheet bundle Pb. Note that a detailed method for forming the toner image “tn” for adhesion by the image forming apparatus 101 is a known technique as disclosed in, for example, Japanese Unexamined Patent Application Publication No. 2004-209858.

FIG. 24B is a schematic view of the booklet Bk formed by center folding and crimp binding in the eighth modification. As illustrated in FIG. 24B, the back portion Cb of the booklet Bk has a square back. Then, the toner image “tn” for adhesion is reheated on the back portion Cb. As a result, the toner image “tn” on an overlapping portion of a plurality of sheets P forming a flat portion (back portion Cb) of a square back exerts adhesive force to perform toner crimp binding.

### Ninth Modification

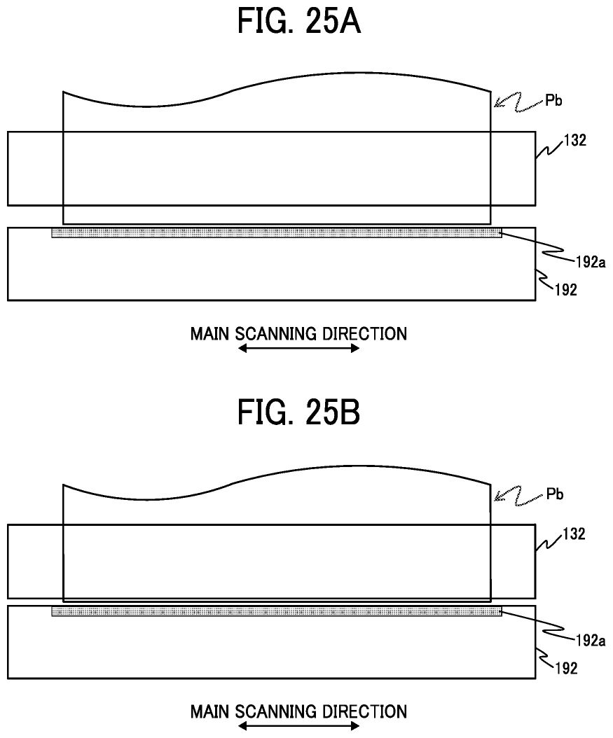

Next, a ninth modification of the crimp center binder will be described with reference to FIGS. 25A and 25B. A crimp center binder according to the ninth modification differs from the crimp center binder according to the eighth modification in that the folding-blade engagement member includes a folding-blade engagement die 192 as a blade member extending in the width direction, instead of a roller member that performs scanning (rotationally moves). Note that constituent elements common to the crimp center binders according to the present modification and the first embodiment are denoted by the same reference numerals, and detailed description thereof will be omitted.

FIGS. 25A and 25B are cross-sectional views of the crimp center binder according to the ninth modification, which illustrate operation of the crimp center binder. FIGS. 24A and 24B are cross-sectional views of the crimp center binder taken along line B-B as viewed from the sheet conveyance direction side at the center line of center folding, that is, at the center position of the thickness of the folding blade 132. FIG. 25A corresponds to the state of FIG. 6C. The folding blade 132 has pushed the sheet bundle Pb to a position beyond the nip position of the folding roller pair 133. The folding-blade engagement die 192 is located at the standby position (HP position), and is separated from the sheet bundle Pb in the center-folding ejection direction.

The folding-blade engagement die 192 is moved toward the folding blade by the folding-blade-engagement-die movement motor 182.

FIG. 25B corresponds to the state of FIG. 6D. The folding-blade engagement die 192 is pressed against the folding blade 132 with the sheet bundle Pb interposed therebetween, and a heat-crimping portion 192a of the folding-blade engagement roller is pressed against the pushing surface of the folding blade 132 to heat and pressurize the sheet bundle Pb interposed therebetween. As a result, the back portion of the sheet bundle Pb is crimped and bound.

### Second Embodiment

A second embodiment of the image forming system according to the present disclosure will be described.

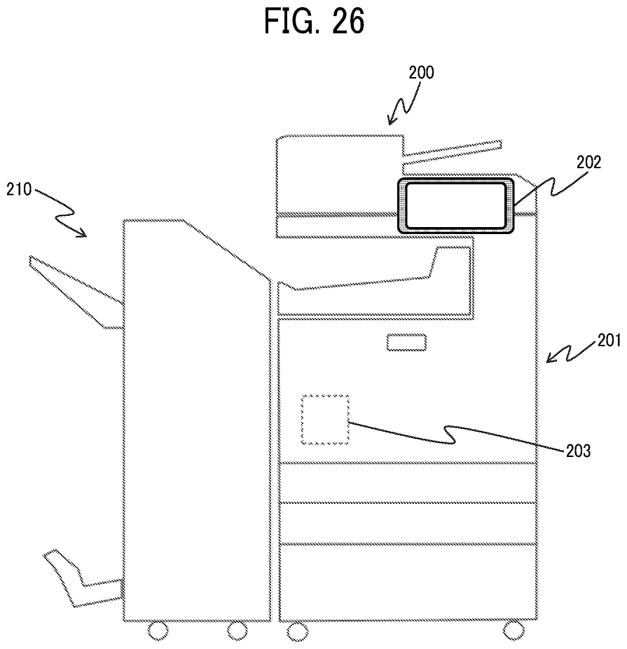

FIG. 26 is a diagram illustrating an overall configuration of an image forming system 200 such as a multifunction printer (MFP), as a second embodiment of the image forming system.

The image forming system 200 has a function of forming an image on a sheet P (medium) and performing post-processing on the sheet P on which the image has been formed. As illustrated in FIG. 26, the image forming system 200 includes an image forming apparatus 201 and a post-processing apparatus 210. The post-processing apparatus 210 is a console-type apparatus disposed adjacent to the image forming apparatus.

The image forming apparatus 201 forms an image on the sheet P, and ejects the sheet P on which the image has been formed to the post-processing apparatus 210. The image forming apparatus 201 includes a tray, a conveyor, and an image former. Sheets P are stored in the tray. The conveyor conveys a sheet P stored in the tray. The image former forms an image on the sheet P conveyed by the conveyor. The image former may be an inkjet image forming device that forms an image with ink or an electrophotographic image forming device that forms an image with toner. Since the configuration of the image forming apparatus 201 is already known, detailed description thereof will be omitted.

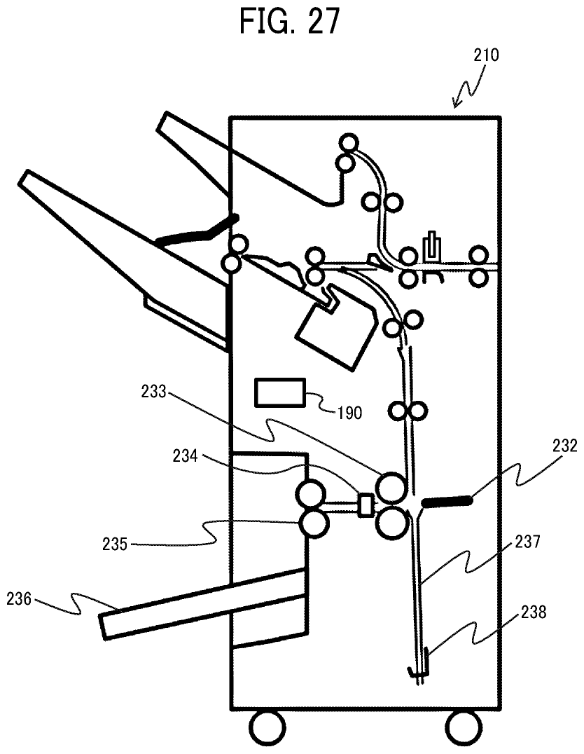

FIG. 27 is a diagram illustrating an internal structure of the post-processing apparatus 210 according to the second embodiment. The post-processing apparatus 210 performs post-processing on the sheet P on which an image has been formed by the image forming apparatus 201. The post-processing according to the present embodiment is binding as a process to bind the sheets P on each of which an image is formed as a bundle of sheets P. In the following description, the bundle of sheets P may be referred to as a “sheet bundle Pb.” More specifically, the binding according to the present embodiment includes so-called “crimp binding” and “stapling.” The crimp binding is a process to press and deform the sheet bundle Pb at a crimp binding position. The stapling is a process to bind the sheet bundle Pb with a staple. The crimp binding includes edge binding and center binding. The edge binding is a process to bind an edge of the sheet bundle Pb. The center binding is a process to bind the center of the sheet bundle Pb.

Constituent elements common to the crimp center binders according to the present embodiment and the first embodiment are denoted by the same reference numerals, and detailed description thereof will be omitted.

### Crimp Center Binding

As illustrated in FIG. 27, the post-processing apparatus 210 includes a folding blade 232, a folding roller pair 233, a folding-blade engagement roller 234, a center-folded booklet ejection roller pair 235, and a center-folded booklet ejection tray 236.

The conveyance rollers place sheets P on a center-binding inner tray 237, and switchback-convey the sheets P on the center-binding inner tray 237 toward a movable end fence 238.

A plurality of sheets P conveyed in sequence is temporarily placed on the center-binding inner tray 237. The movable end fence 238 is movable in a conveyance direction of the sheets P along the center-binding inner tray 237. The movable end fence 238 aligns the sheets P such that the folding blade 232 faces a central position of a sheet conveyance direction length according to a sheet size. The side fence aligns the sheets P or the sheet bundle Pb placed on the center-binding inner tray 237 in a main scanning direction (width direction). A crimp center binder performs center binding on the sheet bundle Pb aligned by the movable end fence 238 and the side fence. The sheet bundle Pb subjected to center binding is ejected by the center-folded booklet ejection roller pair 235, and is placed on the center-folded booklet ejection tray 236.

Embodiments of the present disclosure are not limited to the above-described embodiments and modifications, and numerous additional modifications and variations are possible in light of the teachings. The technical contents included in the technical ideas described in the appended claims are included within the technical scope of the appended claims. The above-described embodiments and modifications are some examples, and various modifications and variations can be practiced from such examples by those skilled in the art. Such modifications and variations are included in the technical scope described in the appended claims.

Aspects of the present disclosure are, for example, as follows.

### First Aspect

In a first aspect, a sheet processing apparatus includes a center folder, a spine crimp binder, and circuitry. The center folder folds a center portion of a sheet bundle including multiple sheets to perform a center-folding process. The spine crimp binder includes a spine former and a crimp binder. The spine former forms a spine on the center portion of the sheet bundle subjected to the center-folding process to perform a spine-forming process. The crimp binder crimps and binds the spine of the sheet bundle subjected to the center-folding process to perform a crimp-binding process. The circuitry is to cause the spine former to form a fold on the spine of the sheet bundle, and cause the crimp binder to form a crimp mark substantially parallel to the fold formed on the spine of the sheet bundle.

### Second Aspect

In a second aspect, in the sheet processing apparatus according to the first aspect, the center folder includes a folding plate and a folding roller pair. The folding plate pushes the center portion of the sheet bundle in a given direction. The folding roller pair nips the sheet bundle, pushed by the folding plate, between the folding plate and the folding roller pair, and rotate and guide the sheet bundle in the given direction.

### Third Aspect

In a third aspect, in the sheet processing apparatus according to the second aspect, the spine former includes the folding plate, and a folding-plate engagement member to engage with the folding plate via the sheet bundle.

### Fourth Aspect

In a fourth aspect, in the sheet processing apparatus according to the third aspect, the folding-plate engagement member is biased toward the folding plate, and the circuitry is further configured to cause the folding-plate engagement member to press the spine of the sheet bundle with the folding plate.

### Fifth Aspect

In a fifth aspect, in the sheet processing apparatus according to the third aspect or the fourth aspect, the folding-plate engagement member includes a roller rotatable around a rotation axis, and the circuitry is further to cause the folding-plate engagement member to reciprocally move in a longitudinal direction of the spine, and perform the crimp-binding process.

### Sixth Aspect

In a sixth aspect, in the sheet processing apparatus according to any one of the third aspect to the fifth aspect, the folding plate includes a folding-crimping teeth portion having a protruding-recessed shape on a face facing the folding-plate engagement member. The folding-plate engagement member includes an engaging-crimping teeth portion having a protruding-recessed shape to engage with the folding-crimping teeth portion. The folding-plate engagement member nips the sheet bundle between the folding-crimping teeth portion and the engaging-crimping teeth portion and is supported to be movable in a main scanning direction of the sheet bundle.

### Seventh Aspect

In a seventh aspect, in the sheet processing apparatus according to any one of the third aspect to the sixth aspect, the crimp binder performs the crimp-binding process and forms the spine, as the folding-plate engagement member moves in a main scanning direction of the sheet bundle.

### Eighth Aspect

In an eighth aspect, in the sheet processing apparatus according to the sixth aspect or the seventh aspect, the folding plate includes at least one folding-plate crimping tooth group having a protruding-recessed shape and disposed on an opposite face opposite to the folding-plate engagement member. The folding-plate engagement member includes at least one engaging-crimping tooth group having an intermittently protruding-recessed portion to engage with the at least one folding-plate crimping tooth group. The circuitry is further to cause the folding plate to move toward the folding-plate engagement member, and perform the crimp-binding process.

### Ninth Aspect

In a ninth aspect, in the sheet processing apparatus according to the fifth aspect, the folding-plate engagement member includes a planar blade disposed opposite to the folding plate. The planar blade is configured to move toward the folding-plate engagement member to perform the crimp-binding process.

### Tenth Aspect

In a tenth aspect, in the sheet processing apparatus according to any one of the first aspect to the ninth aspect, the spine crimp binder includes a first roller having teeth, and a second roller to engage with the first roller via the sheet bundle.

### Eleventh Aspect

In an eleventh aspect, in the sheet processing apparatus according to the sixth aspect, the folding-plate engagement member includes a cylindrical portion having an engaging-crimping teeth, and flanges disposed at both ends of the cylindrical portion and each having a diameter larger than a diameter of the cylindrical portion.

### Twelfth Aspect

In a twelfth aspect, in the sheet processing apparatus according to the eleventh aspect, the flanges are engaged with each other between which the cylindrical portion of the folding-plate engagement member is interposed.

### Thirteenth Aspect

In a thirteenth aspect, in the sheet processing apparatus according to any one of the first aspect to the twelfth aspect, the spine crimp binder forms two fold lines parallel in a longitudinal direction with the spine of the sheet bundle.

### Fourteenth Aspect

In a fourteenth aspect, in the sheet processing apparatus according to the thirteenth aspect, the spine of the sheet bundle is formed to be a substantially flat portion between the two fold lines.

### Fifteenth Aspect

In a fifteenth aspect, in the sheet processing apparatus according the thirteenth aspect, the spine crimp binder includes a folding-crimping teeth portion having a protruding-recessed portion having a single groove on the sheet bundle in a direction along the two fold lines formed on the sheet bundle.

### Sixteenth Aspect

In a sixteenth aspect, in the sheet processing apparatus according to the fifteenth aspect, the protruding-recessed portion is aligned as a repeated pattern in a sub-scanning direction of the sheet bundle.

### Seventeenth Aspect

In a seventeenth aspect, in the sheet processing apparatus according to the fifteenth aspect, the protruding-recessed portions are continuously disposed in the sub-scanning direction of the sheet bundle.

### Eighteenth Aspect

In an eighteenth aspect, in the sheet processing apparatus according to the sixteenth aspect, the protruding-recessed portions are intermittently disposed in the sub-scanning direction of the sheet bundle.

### Nineteenth Aspect

In a nineteenth aspect, in the sheet processing apparatus according to the first aspect, the center folder includes a folding plate to push the center portion of the sheet bundle in a given direction. The folding plate includes multiple protruding-recessed portions intermittently disposed in a main scanning direction of the sheet bundle.

### Twentieth Aspect

In a twentieth aspect, in the sheet processing apparatus according to the first aspect, the crimp binder includes a folding plate to push the center portion of the sheet bundle in a given direction, and a folding-plate engagement member to engage with the folding plate via the sheet bundle. The folding-plate engagement member has protruding-recessed portions intermittently disposed in a main scanning direction of the sheet bundle.

### Twenty-First Aspect

In a twenty-first aspect, an image forming system includes an image forming apparatus to form an image on a sheet, and the sheet processing apparatus according to any one of the first aspect to the twentieth aspect, disposed in an in-body space of the image forming apparatus.

### Twenty-Second Aspect

In a twenty-second aspect, an image forming system includes an image forming apparatus to form an image on a sheet, and the sheet processing apparatus according to any one of the first aspect to the twentieth aspect to perform a given process on the sheet on which the image is formed by the image forming apparatus.

### Twenty-Third Aspect

In a twenty-third aspect, a sheet processing method includes folding a center portion of a sheet bundle including multiple sheets in a center-folding process by a center folder, forming a spine on the center portion of the sheet bundle subjected to the center-folding process to perform a spine-forming process by a spine former, crimping and binding the spine of the sheet bundle subjected to the center-folding process to perform a crimp-binding process in a crimp-binding process by a crimp-binder, forming a fold on the spine of the sheet bundle in the crimp-binding process, and forming a crimp mark substantially parallel to the fold formed on the spine of the sheet bundle in the crimp-binding process.

### Twenty-Fourth Aspect

In a twenty-fourth aspect, a sheet processing apparatus includes a center folder, a back-crimp binder, and circuitry. The center folder performs a center-folding process to form a fold portion on a sheet bundle including multiple sheets. The back-crimp binder includes a back-portion former and a crimp binder. The back-portion former forms a back portion of the fold portion on the sheet bundle subjected to the center-folding process. The crimp binder performs a crimp-binding process on the back portion of the sheet bundle subjected to the center-folding process. The circuitry is to cause the back-crimp binder to form a crimp mark parallel to the fold portion on the back portion of the sheet bundle.

### Twenty-Fifth Aspect

In a twenty-fifth aspect, in the sheet processing apparatus according to the twenty-fourth aspect, the center folder includes a folding plate and a folding roller pair. The folding plate guides a part of the sheet bundle in a first direction. The folding roller pair nips the sheet bundle guided by the folding plate in a second direction intersecting the first direction, and advance the sheet bundle in the first direction.

### Twenty-Sixth Aspect

In a twenty-sixth aspect, in the sheet processing apparatus according to the twenty-fifth aspect, the back-crimp binder includes a folding-plate engagement member to engage with the folding plate via the sheet bundle.

### Twenty-Seventh Aspect

In a twenty-seventh aspect, in the sheet processing apparatus according to the twenty-sixth aspect, the folding-plate engagement member is biased toward the folding plate, and the circuitry is further to cause the folding-plate engagement member to nip the back portion of the sheet bundle between the folding-plate engagement member and the folding plate to press the back portion of the sheet bundle with the folding-plate engagement member.

### Twenty-Eighth Aspect

In a twenty-eighth aspect, in the sheet processing apparatus according to the twenty-sixth aspect or the twenty-seventh aspect, the folding-plate engagement member includes a roller rotatable about an axis, and the circuitry is further to cause the folding-plate engagement member to reciprocally move in a longitudinal direction of the back portion to perform the crimp-binding process.

### Twenty-Ninth Aspect

In a twenty-ninth aspect, in the sheet processing apparatus according to any one of the twenty-sixth aspect to the twenty-eighth aspect, the folding plate has first teeth having multiple protrusions and recesses on a face facing the folding-plate engagement member, the folding-plate engagement member has second teeth having multiple protrusions and recesses to engage with the first teeth, and the circuitry moves the folding-plate engagement member in a longitudinal direction of the back portion of the sheet bundle while nipping the sheet bundle between the first teeth and the second teeth.

### Thirtieth Aspect

In a thirtieth aspect, in the sheet processing apparatus according to the twenty-ninth aspect, the folding plate has at least one first teeth group having multiple protrusions and recesses on a face facing the folding-plate engagement member, the folding-plate engagement member includes at least one second teeth group having an intermittently protruding-recessed portion to engage with the at least one first teeth group, and the circuitry is further to cause the folding plate to move toward the folding-plate engagement member, and perform the crimp-binding process.

### Thirty-First Aspect

In a thirty-first aspect, in the sheet processing apparatus according to the twenty-ninth aspect, the folding-plate engagement member includes a cylindrical portion having the second teeth, and flanges disposed at both ends of the cylindrical portion and each having a diameter larger than a diameter of the cylindrical portion.

### Thirty-Second Aspect

In a thirty-second aspect, in the sheet processing apparatus according to the twenty-fifth aspect, the back-crimp binder includes the folding plate, and a folding-plate-engagement heater including a heater to heat the sheet bundle and press the sheet bundle against the folding plate. The folding-plate-engagement heater heats an adhesive medium in an adhesive portion of the sheet bundle.

### Thirty-Third Aspect

In a thirty-third aspect, in the sheet processing apparatus according to the thirty-second aspect, the adhesive medium includes a toner image as a visible image.

### Thirty-Fourth Aspect

In a thirty-fourth aspect, in the sheet processing apparatus according to the thirty-second aspect, the folding-plate-engagement heater includes a roller rotatable about an axis, and the circuitry is further to cause the folding-plate-engagement heater to reciprocally move in a longitudinal direction of the back portion, and perform a back-portion-forming process and the crimp-binding process.

### Thirty-Fifth Aspect

In a thirty-fifth aspect, in the sheet processing apparatus according to any one of the twenty-fourth aspect to the thirtieth aspect, the back-crimp binder includes a first roller having teeth, and a second roller having teeth to engage with the first roller via the sheet bundle.

### Thirty-Sixth Aspect

In a thirty-sixth aspect, in the sheet processing apparatus according to any one of the twenty-fourth aspect to the thirty-first aspect, and the thirty-fifth aspect, the back-crimp binder forms a crimp mark having at least one single recess on the sheet bundle in a longitudinal direction on the back portion of the sheet bundle.

### Thirty-Seventh Aspect

In a thirty-seventh aspect, in the sheet processing apparatus according to the thirty-sixth aspect, the crimp mark includes multiple recesses, including the at least one single recess, aligned in a lateral direction of the back portion of the sheet bundle.

### Thirty-Eighth Aspect

In a thirty-eighth aspect, an image forming system includes an image forming apparatus to form an image on a sheet, and the sheet processing apparatus according to any one of the twenty-fourth aspect to the thirty-seventh aspect to perform a given process on the sheet on which the image is formed by the image forming apparatus.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. A sheet processing apparatus comprising:
a center folder to perform a center-folding process to form a fold portion on a sheet bundle including multiple sheets; and
a back-crimp binder including:
a back-portion former to form a back portion of the fold portion on the sheet bundle subjected to the center-folding process; and
a crimp binder to perform a crimp-binding process on the back portion of the sheet bundle subjected to the center-folding process; and
circuitry configured to cause the back-crimp binder to form a crimp mark parallel to the fold portion on the back portion of the sheet bundle.

2. The sheet processing apparatus according to claim 1,
wherein the center folder includes:
a folding plate to guide a part of the sheet bundle in a first direction; and
a folding roller pair to:
nip the sheet bundle guided by the folding plate in a second direction intersecting the first direction; and
advance the sheet bundle in the first direction.

3. The sheet processing apparatus according to claim 2,
wherein the back-crimp binder includes a folding-plate engagement member to engage with the folding plate via the sheet bundle.

4. The sheet processing apparatus according to claim 3,
wherein the folding-plate engagement member is biased toward the folding plate, and
the circuitry is further configured to cause the folding-plate engagement member to nip the back portion of the sheet bundle between the folding-plate engagement member and the folding plate to press the back portion of the sheet bundle with the folding-plate engagement member.

5. The sheet processing apparatus according to claim 3,
wherein the folding-plate engagement member includes a roller rotatable about an axis, and
the circuitry is further configured to cause the folding-plate engagement member to reciprocally move in a longitudinal direction of the back portion to perform the crimp-binding process.

6. The sheet processing apparatus according to claim 3,
wherein the folding plate has first teeth having multiple protrusions and recesses on a face facing the folding-plate engagement member,
the folding-plate engagement member has second teeth having multiple protrusions and recesses to engage with the first teeth, and
the circuitry moves the folding-plate engagement member in a longitudinal direction of the back portion of the sheet bundle while nipping the sheet bundle between the first teeth and the second teeth.

7. The sheet processing apparatus according to claim 6,
wherein the folding plate has at least one first teeth group having multiple protrusions and recesses on a face facing the folding-plate engagement member,
the folding-plate engagement member includes at least one second teeth group having an intermittently protruding-recessed portion to engage with the at least one first teeth group, and
the circuitry is further configured to cause the folding plate to:
move toward the folding-plate engagement member; and
perform the crimp-binding process.

8. The sheet processing apparatus according to claim 6,
wherein the folding-plate engagement member includes:
a cylindrical portion having the second teeth; and
flanges disposed at both ends of the cylindrical portion and each having a diameter larger than a diameter of the cylindrical portion.

9. The sheet processing apparatus according to claim 2,
wherein the back-crimp binder includes:
the folding plate; and
a folding-plate-engagement heater including a heater to heat the sheet bundle and press the sheet bundle against the folding plate, and
the folding-plate-engagement heater heats an adhesive medium in an adhesive portion of the sheet bundle.

10. The sheet processing apparatus according to claim 9,
wherein the adhesive medium includes a toner image as a visible image.

11. The sheet processing apparatus according to claim 9,
wherein the folding-plate-engagement heater includes a roller rotatable about an axis, and
the circuitry is further configured to cause the folding-plate-engagement heater to:
reciprocally move in a longitudinal direction of the back portion; and
perform a back-portion-forming process and the crimp-binding process.

12. The sheet processing apparatus according to claim 1,
wherein the back-crimp binder includes:
a first roller having teeth; and
a second roller having teeth to engage with the first roller via the sheet bundle.

13. The sheet processing apparatus according to claim 1,
wherein the back-crimp binder forms a crimp mark having at least one single recess on the sheet bundle in a longitudinal direction on the back portion of the sheet bundle.

14. The sheet processing apparatus according to claim 13,
wherein the crimp mark includes multiple recesses, including the at least one single recess, aligned in a lateral direction of the back portion of the sheet bundle.

15. An image forming system comprising:
an image forming apparatus to form an image on a sheet; and
the sheet processing apparatus according to claim 1 to perform a given process on the sheet on which the image is formed by the image forming apparatus.
